(19) United States
(12) Patent Application Publication
(10) Pub. No.: US 2003/0078987 A1
(43) Pub. Date: Apr. 24, 2003

(54) Navigating network communications resources based on telephone-number metadata

(76) Inventor: Oleg Serebrennikov, Moscow (RU)

Correspondence Address: DARBY & DARBY P.C., 805 Third Avenue, New York, NY, 10022, US

(21) Appl. No.: 10/085,717

(22) Filed: Feb. 27, 2002

(30) Foreign Application Priority Data
Oct. 24, 2001 (RU) 2001128645

(51) Int. Cl. G06F 15/16

(52) U.S. Cl. 709/217

(57) ABSTRACT

Mechanisms for associating metadata with network resources, and for locating and communicating with the network resources are disclosed. Owners of network resources define metadata that describes each network resource. The metadata includes a telephone number related to the network resource, its location, its language, its region or intended audience, and other descriptive information. The owners register the metadata in a registry. To locate a selected network resource, a client provides the telephone number to a resolver process. The resolver process provides to the client the network resource location corresponding to the telephone number. Accordingly, network resources can be located and communications with the resource can proceed merely by providing the telephone number associated with the network resource.

### FIELD OF THE INVENTION

The present invention generally relates to data processing. More particularly, the present invention relates to a system, and method for facilitating information exchange and communications with various communications devices using a telephone number.

### BACKGROUND

U.S. Pat. No. 6,151,624 (hereinafter, “the '624 patent”) of Teare et al., which is hereby incorporated herein by reference in its entirety, and which is considered by applicant to be the closest known art to the presently claimed invention, describes a system and method that facilitates the search and retrieval of network resources, such as a Web page, by utilizing a natural language name. In the case of a Web page, the system and method of the '624 patent associates a natural language name with a Uniform Resource Locator (“URL”) in a metadata file which also contains additional descriptive information about the Web page. Upon entry and submission of a natural language name in a Web browser's data entry field, the system and method consults an indexed database containing metadata information in order to find the corresponding URL associated with the given natural language name. The system and method of the '624 patent thereafter send the corresponding Web page, identified by the associated URL, to the user. In this manner, the user is freed from the constraint of being required to know the complete URL of a desired Web page before being able to access the Web page.

There are, however, several drawbacks and limitations associated with the system and method described in the '624 patent. As the '624 patent itself acknowledges, a natural language name is not unique and any particular natural language name provided by a user may result in more than one Web page from which the user must select. Accordingly, the '624 patent provides additional data and network processing for resolving such conflicts.

Moreover, a natural language name may be protected by trademark or domain name registration and, accordingly, may be off-limits to a Web site administrator desirous of associating his Web site with a particularly appropriate, but legally protected, natural language name.

Moreover, the '624 patent does not address communications with other communication facilitating resources and methods, e.g., email, voice mail and PDA devices.

What is desired, therefore, and has heretofore not been available, is a system and method which allows a user to utilize unique descriptive information to identify, retrieve and interact with Web sites or other network-based resources using information that is unique and known.

### SUMMARY OF THE INVENTION

The foregoing needs, and other needs and objects, are fulfilled by the present invention, which comprises, in one aspect, a method of locating and communicating with networked resources using a telephone number, and a location identifier, comprising the steps of storing a first telephone number of the resource in association with the location identifier of the resource; receiving a request to locate the resource containing the first telephone number; retrieving the location identifier associated with the first telephone number; and communicating with the resource using the location identifier.

One feature of this aspect involves storing at least a second telephone number for the resource, in association with the location identifier; receiving requests to locate the resource based on the first or second telephone number; retrieving the location identifier associated with the first or second telephone number; and communicating with the resource using the location identifier. Another feature involves the steps of storing the first and second telephone numbers in association with the location identifier, and in a number file in a storage device associated with the resource.

Yet another feature involves the steps of retrieving a number file including a telephone number and an associated resource; parsing the number file; building an index entry based on the values parsed from the number file; and storing the index entry in an index that is stored apart from the storage device. Still another feature is the steps of sending the number file over the network to a client associated with the resource; and storing the number file in a server storage device of a server associated with the client. Another feature involves periodically polling the number file on the server associated with the client; testing whether one of the telephone numbers stored in the number file matches a third telephone number stored in a database indexed by the index; and updating the database when changes are detected in the number file. Yet another feature is the step of synchronizing the index to the database.

According to another feature, the method includes the steps of receiving a client identifier of a client associated with the resource; generating a set of metadata that describes the resource, the location identifier, and the client identifier; and storing the set of metadata in a persistent storage device associated with the client. Another feature is assigning a randomly generated name to the set of metadata. Yet another feature is instructing the client to store the metadata in a particular authorized location in the persistent storage device. Another feature is registering the set of metadata and the randomly generated name in a database.

The foregoing is merely a brief summary of various aspects of the invention. The invention encompasses many other aspects, as set forth in the appended claims.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a diagram of a number file.

FIG. 1B is a block diagram of one embodiment of a system for navigating network resources based on metadata.

FIG. 2A is a flow diagram of a method of a registration service in the system of FIG. 1B.

FIG. 2B is a flow diagram of a method of activating a number file in the system of FIG. 1B.

FIG. 3 is a flow diagram of a method of operating a crawler in the system of FIG. 1B.

FIG. 4 is a block diagram of an index builder service of the system of FIG. 1B.

FIG. 5 is a flow diagram of a method of operating a resolver service in the system of FIG. 1B.

FIG. 6 is a flow diagram of a method of operating a number finding service in the system of FIG. 1B.

FIG. 7A is a diagram of an exemplary statistics report page generated by the system of FIG. 1B.

FIG. 7B is a diagram of another exemplary statistics report page generated by the system of FIG. 1B.

FIG. 8 is a block diagram of a computer system that can be used to implement the present invention.

FIG. 9 is a simplified block diagram of a resolution and navigating system.

### DETAILED DESCRIPTION OF AN EMBODIMENT OF THE INVENTION

A mechanism for associating network resources with a telephone number and locating and communicating with network resources using the associated telephone number is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form or otherwise explained in a manner that avoids unnecessarily obscuring the present invention.

Number File Format

In one embodiment of the present invention, metadata is associated with network resources such as a Web page, networked computers, Web-enabled appliances or wireless or other communications devices. Generally, metadata is data that describes other data. The metadata defined herein provides information that describes a Web page or other networked communication resource in a manner analogous to the manner by which a catalog card describes a book in a library. For example, the metadata includes information that provides a telephone number associated with the Web page or other networked resource, a description of the resource, a language designation of the resource, a geographical location associated with the networked resource and other information pertinent to the resource. Continuing with the example of a Web page, the metadata is defined by an administrator of the server that stores the Web pages that are described in the metadata, and a copy of the metadata is stored in association with that server so that the metadata is accessible using the Web. Using a Librarian, the copy of the metadata is registered with a database that is coupled to an index. In this manner, a Web site may be identified by typing a known telephone number (stored with associated information in a metadata) into a Web browser. Thereafter, the information in the metadata is used to resolve the telephone number into the Web site associated with the telephone number in the metadata.

As stated, the metadata may associate other communications resources, in addition to Web pages, with a telephone number. For example, the metadata may associate a telephone number with a user's instant messaging facility, wireless telephone number (when the telephone number upon which the metadata is based is a landline phone) or even a user's internet video conferencing facility. In this manner, a telephone number and associated metadata can be utilized to locate a myriad of communication facilities associated with a telephone number in addition to a Web page.

While the following description of various embodiments of the present invention deals primarily with the resolution of Web page resources using telephone numbers, it is understood that one skilled in the art would be able to easily modify the teachings herein to accomplish resolution of other communication resources using a telephone number as described below.

Preferably, the metadata is prepared and initially stored in the form of a Number File 64 which is a text file defined by the Extensible Markup Language (XML) grammar. XML is a language definition promoted by Microsoft® Corporation and Netscape® Communications Corporation. Further information about XML is provided in “XML: Principles, Tools, and Techniques,” The World Wide Web Journal, vol. 2, no. 4 (Fall 1997) (Sebastopol, Calif.: O'Reilly & Assoc., Inc.).

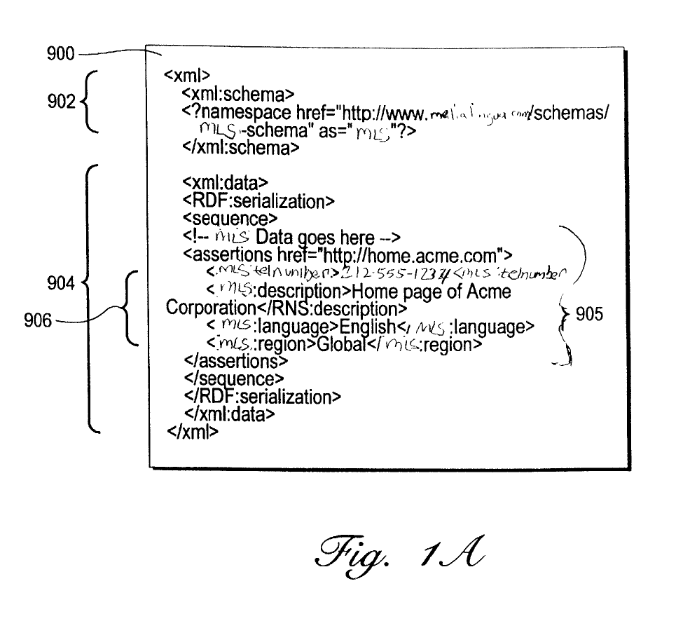

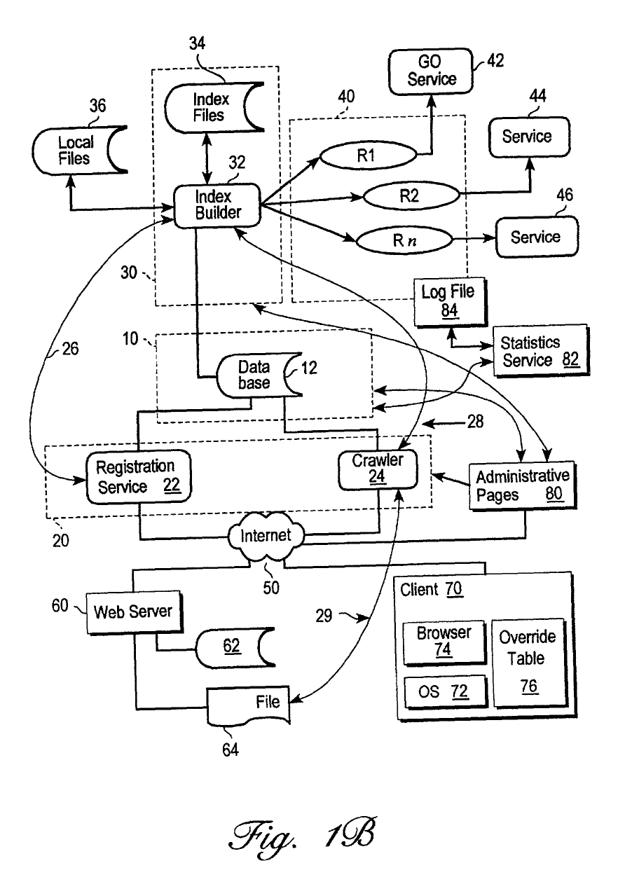

Preferably, the text in the Number File 64 is compatible with the Resource Definition Format (“RDF”) format and CC/PP (Composite Capabilities/Preference Profiles) RDF-based framework for the management of device profile information, as well as with other XML initiatives related to Web-enabled and wireless appliances' metadata description. RDF is a syntax of XML designed by the World Wide Web Consortium for expressing semantics. The text file for the metadata described herein is also called an MLS file. An example of an MLS file is set forth in FIG. 1A.

The MLS file 900 is defined according to a grammar in which information elements are surrounded by complementary tags. For example, “<resource>” and “</resource>” are complementary tags. The MLS file 900 has two general parts, namely a schema section 902, and a data section 904. The schema section 902 and the data section 904 are enclosed within complementary tags (“<xml>, </xml>”) that indicate that the MLS file 900 is in the XML grammar.

The schema section 902 is delineated by the <schema> and </schema> tags. The schema section identifies the schema that is used to organize data in the data section. In the example of FIG. 1A, an “href” anchor code in the schema section refers to a file, “MLS-schema”, located on a Web server, that contains the schema definition. The schema is assigned the name “MLS. ” Tags in the MLS file 900 that are part of the MLSschema have a prefix of “MLS”. Based on this prefix, the XML parser that reads the MLSfile 900 can identify tags that are part of the MLS schema.

The data section 904 is delineated by the <xml:data> and </xml:data> tags. The data section contains one or more MLS entries 905. Each MLS entry 905 is delineated by the tags <assertions> and </assertions>. Conceptually, each MLS entry 905 is a set of assertions about a network resource that is identified within the <assertions> tag. In the example of FIG. 1A, one MLS entry 905 makes assertions about the network resource home.acme.com, which for exemplary purposes is the home page of a fictional company, Acme Corporation. Of course, in accordance with the present invention, the <assertions> tag may make assertions about resources other than Web pages. For example, the <assertions> tag may define a user's instant messaging “buddy” name.

In a further embodiment of the present invention, more than one type of resource may be associated with a telephone number and the various resources made available based on the availability of a particular resource. For example, a landline telephone number of a user may be associated with that user's instant messaging “buddy” name, SMS identifier, and online video conferencing facility, e.g., Microsoft NetMeeting□. The number file defining these various resources lists the resources in a hierarchical order, e.g., instant messaging, then video conferencing, then SMS messaging and is preferably constantly updated as to the on-line availability of each of the resources in accordance with known methods. Thus, when an attempt is made to contact the user by using the landline telephone number, the resource to be utilized to facilitate contact is determined based on the defined hierarchy and the on-line availability of the particular resource sat that instances. Continuing with the above example, communication will be made via instant messaging unless the user is not “on-line” with his instant messenger at which point communications will be attempted via video conferencing. If the user is not on-line via video conferencing, communications will be made via SMS. Other communications facilities may also be offered, e.g., a voice or video message may be stored for delivery to the user.

The metadata file of the present invention provides a uniform addressing scheme based upon a telephone number. The metadata file in combination with the uniform addressing scheme allows communications between and among different types of devices operating on disparate networks. As another example, the metatdata file of the present example can be used to facilitate addressing between an internet-based video conferencing system and a mobile telephone with videoconferencing capabilities, e.g., a 3G-based mobile phone with video capabilities. In this context, a connection may be initiated by the internet-based videoconferencing user by typing the telephone number into the address bar which is resolved by the metadata file into the videophone resource.

The RDF language provides a general mechanism for describing many types of resources. RDF does not inherently provide facilities for describing Web pages. Accordingly, a Number File 64 is expressed in an RDF vocabulary that is specific to Web pages that expresses the main attributes of a Web page. The attributes include a telephone number associated with the Web page, and preferably also includes a location identifier or URL, a description, a language attribute, a region attribute, and a listings attribute. Of course, one skilled in the art will appreciate that other attributes may be utilized for non-Web page resources as appropriate.

Each MLS entry 905 has a set of metadata 906. In the example of FIG. IA, the metadata 906 contains a value that identifies the telephone number associated with the resource. The real telephone number value, “212-555-1234” is between the <telnumber> and <telnumber> tags. The metadata 906 also includes a description value, a language identifier value, and a region identifier value. A pair of tags delineates each value. For example, in FIG. 1A, the description value is “Home Page of Acme Corporation,” the language value is “English,” and the region value is “Global. ” The description value provides a description of the network resource that is associated with the real telephone number which, in the present example, may be the main corporate telephone number for Acme Corporation. In accordance with the present invention, the telephone number may include an area code or a country code, and may include numeric, alphanumeric or mixed prefixes or extensions, e.g., 1-800-USA-RAIL, or any other type of symbol commonly used with telephone numbers.

When multiple resources are defined in one MLS file, it is preferred that for security reasons, each network address declared for a resource must be related to the shortest network address that is declared in the MLS file for any resource. In the preferred embodiment, each network address must be logically subordinate to or descended from the network address in the MLS file that is shortest in characters. For example, in the excerpt provided in FIG. 1A relating to Web pages, all subsequent resource declarations would be required to identify network addresses that specify files located within the directory tree for which www.medialingua.com is the root node. This relationship is checked by the Registration Service 22 when the MLS file is initially created.

Of course, as described above, a non-Web page resource, e.g., an email address or a “buddy” identifier from an instant messaging buddy list, may be the resource defined in the MLS file.

Another key advantage of this mechanism is that it can be used to provide access to network resources using multiple telephone numbers. One or more Number Files 64 are established. The Number Files 64 store a plurality of entries. Each of the entries stores a telephone number associated with a certain one or more network resources in association with the <telnumber> field. However, each of the entries references the same network resource in association with the <resource> tag.

For example, one or more Number Files 64 have entries that respectively store a telephone number for Acme Corporation such as the main number for the legal, marketing, engineering and sales departments. Each entry identifies the same network resource. Accordingly, the entries establish a plurality of telephone numbers, all of which point to, or resolve to, the same network address. When a third party wishes to access the referenced network resource, the third party uses whatever telephone number of the network resource that is known to the third party. The Resolver will resolve the telephone number, regardless of which telephone number is entered, to the same network address. Accordingly, a user can locate and access network resources using any one of a plurality of known telephone numbers.

In an alternative embodiment, the attributes also include a listings attribute set off by the tag <MLS:listings>. A listings attribute is one or more keywords or other values that describe other properties of a resource. For example, each resource has a subject property that identifies the general nature of the product, service, or organization that is associated with the resource. This enables the database to be organized like a “yellow pages” directory. As an example, Acme Corporation includes in its NumberFile 64 the line <MLS:listings> Anvils, Rockets, Slingshots to indicate that it is a manufacturer of anvils, rockets, and slingshots.

In an alternative embodiment, the resources described in the Number File 64 are persons rather than Web pages. A resource of type “person” has metadata including a mailing address, email address, and other personal information. In this embodiment, the system can be used as a person locator service rather than for navigating to Web pages or other network resources.

As an example, a resource of a person locator service may include links to Web pages whereby a user may send email to the resource owner. Additionally or in the alternate, the resource may provide links that include options to send an SMS message, page or other messaging communication to the resource owner. Moreover, ftp or other links to data associated with the resource owner may be provided at the Web pages. In this manner, the telephone number in the <telnumber>field of Number File 64 acts as a “Personal Internet Address” (PIA), i.e., a unifying personal identifier that can be utilized by others to contact, send and/or gain information about the resource in a variety of ways, e.g., direct dial, e-mail, ftp downloading or uploading, messaging, chatting, sending or scheduling a task or meeting request, leaving voice mail or a video message or checking the on-line status of the PIA owner. The usefulness of the telephone number associated with the person locator service is augmented where the telephone number is both a landline and a mobile telephone number, e.g., as in “one call” services offered by various TELCO and wireless providers that automatically ring a predefined mobile telephone when there is no answer at the landline telephone.

In instances where the resource provides means for sending messages, the sender's identification may be captured from the user's computer and operating system settings. For example, when sending an email, the present system may capture the sender's identity by referencing the Window operating system's ID setting as defined in the Start/Settings/Control Panel/Users/Properties setting. In this manner, the resource to which the message is sent will have an identification of the sender whereby the resource may respond to the message.

In accordance with various embodiments of the present invention, the resources described in the Number File 64 are wireless devices , Web enabled appliances or other communication facilities other than Web pages or persons. For example, a resource of type “device” has metadata defining the device, e.g., screen size, available memory, type of communication available, mailing address associated with the device, email address, a request for resource renewal,e.g., to attend to paper refill when a networked printer (the resource) is detected to have run out of paper, and other information. In this embodiment, the system can be used as a device locator, resource availability and status service rather than for navigating to Web pages or other network resources.

In other alternative embodiments, the Number File 64 may store other or additional attributes. For example, other attributes include Organization, Subject, Abstract, Type, Audience. The Organization attribute the Organization attribute the Number File 64 information that may identify an organization or company that owns or is associated with the network resource, for example, “Federated Stores Incorporated.” In the Subject attribute, the Number File 64 stores information that describes the subject matter of the network resource, for example, “dogs.” In the Abstract attribute, the Number File 64 stores information containing an abstract of the network resource. In the Type attribute the Number File 64 stores information describing a type of the network resource, for example, “RealAudio file”. In the Audience attribute, the Number File 64 stores information describing the intended audience of the network resource, for example, “Women age 19-34”.

Defining metadata for a network resource, associating the metadata with a network resource, and storing a copy of the metadata on a server that contains the network resource in this manner offers significant advantages. For example, maintenance of the metadata is convenient. Since a copy of the metadata is stored locally on the server that contains the network resource, the metadata can be updated at any time without contacting a central service. As described further herein, a metadata crawler mechanism periodically visits the server to monitor changes in the metadata. If a Number File 64 has changed, after validation, the changes are automatically propagated to the database and the index.

In addition, in combination, the Number Files 64 operate as a distributed database of metadata. Maintaining a distributed database enhances scalability, because modifying the metadata is not dependent upon the availability of a single centralized database. Further, by storing the metadata files in association with the server of a device on which the network resources are located, data integrity is improved. Only a user having authorization to store files on a server can create metadata mappings that reference network resources on that server.

Of course, one skilled in the art will appreciate that the metadata may, alternately or in addition, be stored at a central database. The central database may be periodically updated by the various respective network servers that contain the resource or information about the resources, or may be manually updated by a central administrator.

Yet another advantage is multi-lingual compatibility. The XML language supports the UNICODE character encoding standard. As a result, attributes stored in a Number File 64 can be expressed in any human language.

Telephone Number System

Using the metadata stored in Number Files 64, in combination with a network resource locating system, attributes of a network resource can be used to locate and communicate with the network resource. For example, as described above, the telephone number attribute of a Number File 64 can be used to locate a Web page. FIG. 1B is a block diagram of an embodiment of a network resource locating system comprising a Registry 10, a Librarian 20, an Index 30, and a Resolver 40. One skilled in the art will appreciate that variations in the presently described network resource locating system may be realized for resources other that Web pages.

It is understood that as used above and hereinafter, the term “network address” refers generally to an unambiguous identifier of the location of a network resource, one example of a network address being a URL.

The Registry 10 includes a database 12 in the form of a commercial database system, such as the SQL Server, or a proprietary database. The Registry 10 provides a centralized storage point for mappings of telephone numbers to network addresses or URLs, as well as descriptive information associated with the telephone numbers. By definition, each telephone number is unique across the Internet or any other communications network and, therefore, is unique within the Registry 10. The Registry 10 operates as a centralized, highly robust, and scalable persistent storage area for all metadata. The Registry 10 also stores statistics related to the usage of the metadata in the context of various services that are built on top of the Registry, such as the GO navigation system described herein.

Telephone numbers, network addresses, and the descriptive information are loaded into the Registry 10 by the Librarian 20. In the preferred embodiment, the Librarian 20 and the Index 30 communicate with the database 12 using an ODBC interface. In the preferred embodiment, the database 12 has a capacity on the order of several hundred million entries. The Registry 10 and database 12 help ensure a consistent structure and vocabulary across Web sites or other utilized resources.

The Librarian 20 has a Registration Service 22 and a Crawler 24, each of which is coupled to the database 12 and to a network such as the Internet 50 or other communication networks. The Registration Service 22 receives new mappings of telephone numbers to network addresses, and descriptive information, and loads them into or “registers” them with the Registry 10. The Registration Service 22 receives the mappings from a client 70 over the Internet 50. The Crawler 24 traverses or crawls the Internet 50, periodically connecting to registered Web servers that are connected to the Internet, to locate changes to the mappings stored in or in association with the Web servers.

The telephone number system interacts with one or more Web servers or other resources that are connected to the Internet 50. As an example, one Web server 60 is shown in FIG. 1B, but any number of Web servers can be used in connection with this embodiment. A local database 62 is coupled to the Web Server 60 so that the Web Server can retrieve values from the local database for use in Web applications running on the Web Server.

A Number File 64 is also stored in association with the Web Server 60 such that the Web Server can retrieve the Number File and forward its contents to the Internet 50 in response to a request. In the preferred embodiment, the Number File 64 stores one or more telephone number entries. Each telephone number entry contains a telephone number of a resource in the Web Server 60, a description of the resource, a network address, or other identifier of the location of the resource, and other information about the resource such as its language and intended geographic region of use. Preferably, the Number File 64 also stores an identifier of a grammar that is used to format the other information in the Number File. In this way, the information in the Number File is self-describing and language-independent.

As indicated by path 29, the Crawler 24 can contact the Web Server 60 and retrieve values stored in the Number File 64 using a connection through the Internet 50. As indicated by path 28, the Crawler 24 can notify the Index 30 that the Index Files 34 need to be updated to reflect a change in the information stored in the Number File 64.

The Index 30 is coupled to the Registry 10. The Index 30 comprises an Index Builder 32 and one or more Index Files 34 that contain an index of all telephone numbers, telephone number entries, and resources known to the system. For example, the Index Files 34 has index entries for values stored in the Number File 64. The Index Files 34 are constructed, managed, and updated by the Index Builder 32.

Generally, in the preferred embodiment, the Index Files 34 are more compact than the indexes maintained by conventional search engines, because the amount of information represented in all the Number Files 64 is far less than the total content of all network resources available on the Web. Such compactness is a distinct advantage, providing greater scalability and responsiveness than conventional search engines. In addition, the compact size of the Index Files 34 allows the Index 30 to be replicated in multiple different geographic locations.

The Resolver 40 comprises one or more resolver processes R1, R2, Rn, each of which is coupled respectively to a Service 42, 44, 46. Each resolver process R1, R2, Rn communicates with its respective Service 42, 44, 46 to receive requests containing a telephone number, convert or resolve the telephone number into a network address associated with the telephone number, and forward the network address and other information associated with the telephone number to the requesting Service.

A client 70 is coupled to the Internet 50. The client is a computer, server, Web enabled appliance or wireless device or network in which a Web browser 74 runs under control of an operating system 72. An example of the Web browser 74 is Netscape Communicator.RTM., and an example of the operating system 72 is Microsoft Windows 95.RTM.. The services of the telephone number system are accessible to the client 70 over the Internet 50 using the browser 74 according to standard telecommunication or Internet and Web protocols.

For example, under control of the browser 74 and the operating system 72, the client 70 can establish an HTTP connection through the Internet 50 to the Registration Service 22. The browser 74 retrieves pages or forms from the Registration Service 22 that are prepared in the HTML language. The browser 74 displays the pages or forms. A user of the client 70 reads the pages, or enters information in a form and sends the filled-in form back to the Registration Service 22. In this way, the client 70 and the Registration Service 22 carry out a dialog by which a user of the client 70 can perform functions offered by the system.

Preferably, the Registration Service 22, Crawler 24, Index Builder 32, and Resolver 40 are one or more computer programs having the functions and procedures described herein. In one embodiment, each of the Registration Service 22, Crawler 24, Index Builder 32, and Resolver 40 is an independent process, and one or more instance of each such process can be active and executing at a given time. In the preferred embodiment, the computer programs are constructed using an object-oriented programming language and related tools, such as the Java.. language.

The Registration Service 22, Crawler 24, Index Builder 32, and Resolver 40 preferably execute on one or more server computers that can rapidly access, manage, and update the database 12 and index files 34. The foregoing elements can be distributed or segregated. For example, it is contemplated that the Resolver 40 and its processes R1, R2, Rn execute on one server computer, and the Registration Service 22, Crawler 24, and Index Builder 32 operate on the same computer or on a set of computers separate from the server that hosts the Resolver 40. In this configuration, the Resolver 40 can rapidly receive and respond to client requests for access to network resources that are indexed in the Index Files 34, without affecting or interfering with the other elements and their functions.

In one embodiment, the Librarian 20, and other functions of the system, are accessed by connecting the client 70 to one or more administrative Web pages 80 that implement the functions, using an HTTP connection. The administrative Web pages 80 are hosted on a Web server and are generated by a Web server application that can communicate with the other elements of the system. The Web server application sends a top-level page to the client 70. The browser 74 of the client displays the top-level page, which presents a menu of options for working with the system. For example, preferred menu options are set forth in Table 1.

TABLE 1
TOP LEVEL MENU OPTIONS

MLS FILE
Create
Activate
Modify
Delete
STATS & BILLING
Stats
Billing
CUSTOMER
New Customer
Modify Profile
Change Contacts
Logout

Each of the top level menu options can be selected by moving the cursor generated by the client 70 over the name of the desired option, using the client's pointing device, and clicking on the desired option. The functions carried out by selecting each menu option are described below in the context of the functional module that carries out the functions.

In the preceding discussion, the elements of the system have been described with respect to the Internet 50 as an interconnecting element. However, the Internet is merely one example of an interconnecting element that can be used to facilitate communication among the elements of the system. Other elements, such as local-area networks, wide-area networks, other wired and wireless networks, Intranets, and extranets can be used. Also, the protocols that define the Internet, such as Transmission Control Protocol and Internet Protocol, are not required; other protocols are suitable and can be used.

In this configuration, the system has numerous advantages over prior approaches. For example, customer Web sites 60 are isolated from the database 12. The Index Files 34 are separate from the database 12 and only the Index Files are accessed by the Resolver 40. This reduces database loading and increases responsiveness, and provides scalability. The architecture is well suited to distributed replication of the Index Files.

Customer Profile Functions

In one embodiment, the system provides a set of customer information management functions that store, track, and update information about customers of the system. The information managed for each customer is called a customer profile. The customer profiles are stored in the database 12.

When the Customer/New Customer option is selected, the system generates one or more Web pages containing forms that enable a user to enter a new customer profile. The form has fields for entry of a name, address, telephone number, contact person, and payment method. The Web pages and forms are communicated to the client 70 and displayed by the browser. The user of the client 70 enters appropriate information into the data entry fields and clicks on or selects a “SUBMIT” button on the Web page. In response, the client 70 returns the filled-in form in an HTTP transaction to the system. The system extracts the entered information from the fields and stores the information in a table of the database 12.

In the preferred embodiment, the Customer/New Customer registration process is initiated using a Web page generated by the system in the form shown in Table 2:

TABLE 2
REGISTRATION HOME PAGE

Welcome to the Telephone Number System registration site. Before you
can submit your Telephone Number, you need to provide us with some
information about you and the organization that you may represent.
To initiate the registration process, you first need to enter your email
address as your login name, and select a password.
You will need to remember this login name and password, as the
Telephone Number System uses them to grant you access privileges.
Name
Password
[BACK] [NEXT]

In Table 2, the designations [BACK] and [NEXT] represent function buttons. The user enters the user's email address in the Name field, and a user-selected password in the Password field. When the user clicks on the NEXT function button, the Name and Password are stored in the database 12 in association with one another.

Preferably, the system then displays a Web page containing a form that enables the system to receive further information about the user. The form may have fields for entering the user's name, address, city, state, postal code, nation, and telephone number, instant messaging or buddy list identification, e-mail address, mobile and fixed line service providers, equipment type and model number. The user enters the requested information and clicks on a NEXT button. Alternately, or in addition, certain of the information may be retrieved from information already available at the user's computer, e.g., preferred language settings or country and area code information stored in the user's Web browser or in the user's Windows® operating system. The system checks each value to verify that it matches the proper data format required for the corresponding field. The values are stored in the database 12 in association with the user's name and email address. Collectively, this information is the customer profile. Once the customer profile is established, the user can create telephone number entries and store them in one or more Number Files 64.

Selecting the Customer/Modify Profile option causes the system to generate a Web page containing a form that enables a user to change a previously entered customer profile. To ensure secure operation, the user's IP address is extracted from the HTTP transaction that the user used to request the Customer/Modify Profile option. The user is permitted to view and modify only that profile that corresponds to a previously created Number File that is stored on a server having the same IP address as the user. Based upon the user's IP address, the system looks up the corresponding profile in the database 12 and retrieves the contents of the profile. The contents of the profile are displayed in the Web page.

The user may then move the cursor generated by the client 70 to any of the data values displayed in the Web page and enter modifications to the values. When the user selects or clicks on the “SUBMIT” button, the Web page containing the filled-in values are returned to the system in an HTTP transaction. The system updates the database 12 using the values in the page.

Selecting the Customer/Change Contacts option enables the user to change the billing contact associated with a registered Number File. Selecting the Customer/Logout option enables the user to terminate the current session, or log in as a different customer. These functions are provided using a Web application that receives and loads appropriate values into the Registry.

Registration Service

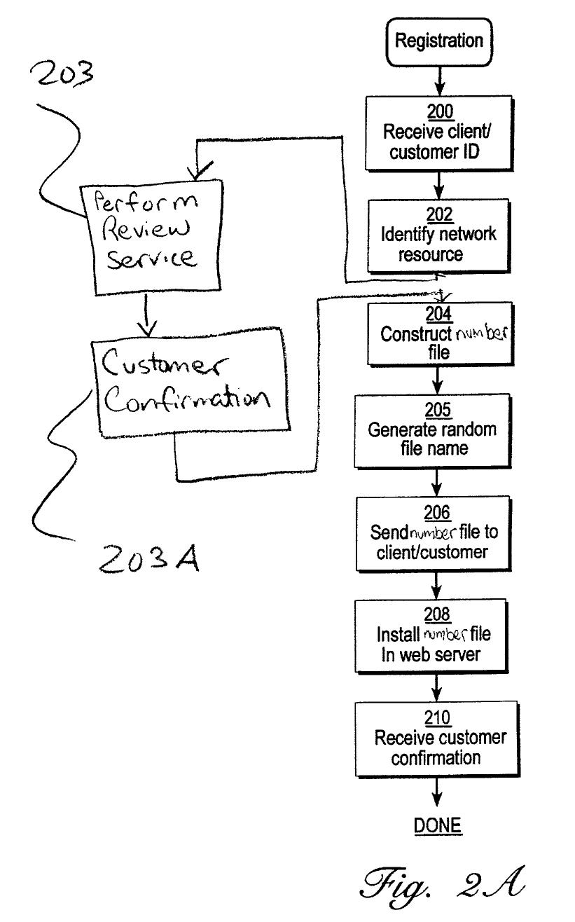

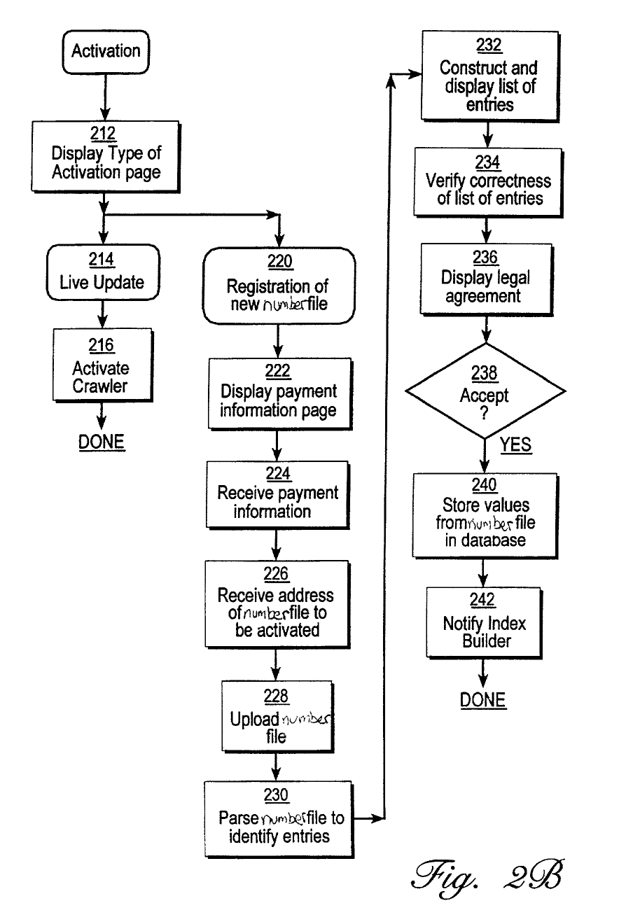

FIG. 2A is a flow diagram of an embodiment of a preferred method of operating the Registration Service 22 of the Librarian 20.

Preferably, the Registration Service 22 has a Web page interface by which one or more clients 70 can access functions offered by the Registration Service by selecting function buttons of the Web pages to activate the functions.

The primary function offered by the Registration Service 22 is registration of new telephone numbers into the Registry 10. In one embodiment, the Registration Service 22 is invoked by selecting the Create option from the top-level menu page. As shown in block 200, an external user or “customer” of the system identifies himself or herself to the system so that information entered later can be associated with the customer. This information includes an electronic mail address of the customer whereby messages can be directed from the Registration Service 22 to the customer over the Internet 50. In this context, the terms “customer” and “user” refer to the operator of a computer remotely connected to the system, for example, the client 70.

As indicated in block 202, the customer then provides information to the Registration Service 22 that identifies a network resource of the Web Server 60, by its location, its telephone number, and descriptive information about the network resource. For example, the customer enters the telephone number “212 555 3000” (the main number for the company named XYZCorp), the URL http://www.xyzcorp.com, and a description about the resource. Preferably, this information is entered in fields of a Web page that is constructed for the purpose of receiving the information, in the form shown in Table 3:

TABLE 3
TELEPHONE NUMBER ENTRY PAGE

| | |
|---|---|
| Telephone Number: | 212-555-3000 |
| URL: | http://www.xyzcorp.com. |
| Type: | company |
| Language: | English |
| Region: | North America |
| Description: | This is the home page for the widget manufacturers, |
| | XYZ Corp. |
| [BACK] [NEXT] | |

When the user has entered all the information, to continue processing of the Number File 64, the user clicks on the NEXT function button at the bottom of the page.

In response, at step 203, the system initiates a review service whereby a cost of providing the described resolution service is calculated. As an example, a flat fee may be charged based on the expected number of resolutions for a certain resource on a per month basis. The expected number of hits for any particular site may be based on a recorded history of past activity at the site. As an example, MSN provides a service that documents the number of hits at various Web sites on a per month basis. By referencing this database, the system may determine how many hits will be expected at the Web Site identified by the user and the system may charge the user accordingly, either in advance or on a forward-looking basis.

At step 203A, the user is informed of the charge for providing the resolution service and either refuses the charge and exits the program or accepts the charge and proceeds to step 204.

At block 204, the Registration Service 22 constructs a Number File 64 based on the information entered by the customer. At this point, the Number File 64 is stored on a server accessible to the Registration Service 22. However, the Number File 64 is not yet stored in association with the Web server 60.

In block 205, the Registration Service 22 generates a file name at random for the Number File 64. A random file name is used in order to prevent unauthorized programs, processes, or users from identifying or modifying the Number File 64 when it is stored in association with the Web Server 60. If the same file name was used, at any Web server registered with the Registry 10, an unauthorized user could modify an entry stored in the Number File 64 to reference a different network resource. Eventually, as will be discussed further below, the Crawler 24 would detect the modification and store the telephone number in the Registry 10. Accordingly, it is desirable to hide the name of the Number File 64 from all unauthorized users.

In block 206, the Number File 64 is sent as a file attachment to an electronic mail (“email”) message to the customer. Block 206 includes the step of receiving an email address from the user. In the preferred embodiment, the system displays a Web page having a data entry field for the email address, in the form shown in Table 4:

TABLE 4
EMAIL ENTRY PAGE

Please enter your email address so that we can send
you the telephone number file that you have just built.
joe@xyzcorp.com
[BACK] [NEXT]

After sending the Number File 64 in an email to the user, the system displays a confirmation page at the client 70. In the preferred embodiment, the confirmation page has the form shown in Table 5.

TABLE 5
CONFIRMATION PAGE

Your Telephone Number File has been mailed to the address
joe@xyzcorp.com. You should now save this file on your Web
site according to the instructions in the email that you will
receive. Once this step is accomplished, the file will have to be
activated through the Telephone Number file activation service.
(Simply follow the previous link, or in Customer Service, look
for the menu item Activate under the MLS File category.)
[FINISH]

In block 208, the customer installs the Number File 64 in the Web Server 60 or in a manner that is accessible to the Web Server. Preferably, the Number File 64 is stored in a location on the Web Server 60 that is specified by the Registration Service 22. For example, the email specifies that the Number File 64 shall be stored in the root directory of the network resource that is named in the Number File 64. This is done to ensure that the receiving customer individual is authentic; the Registration Service 22 presumes that only an authentic customer representative would have root directory access to the Web server on which the named network resource is located. The root directory is also specified for the convenience of the customer. When the Number File 64 is stored in the root directory of the Web server, the customer can modify or reorganize the Web server without affecting the Number File. Conversely, if the Number File 64 was stored in a subordinate directory of the Web server, then there would be a risk of disabling the Number File by accidentally deleting its directory.

In block 210, the customer confirms to the Registration Service 22 that the Number File 64 has been stored in the specified location by the customer. The customer confirmation can be provided in an email directed to the Registration Service 22 or by entering an appropriate command using the Web interface of the Registration Service 22.

Thereafter the user is required to activate the Number File. Activation is a process of verifying that the Number File is stored in the correct location by an authorized user. Optionally, the activation process also includes the process of arranging payment for the privilege of having a registered Number File recognized by the system. One embodiment of an activation method is shown in FIG. 2B.

In the preferred embodiment, the user activates a Number File after creating it by selecting the MLS File/Activate function from the top-level menu option list. In response, as shown in block 212, the system constructs a page that requests the user to enter a type of activation, and sends the page to the client, which displays it. For example, the system displays a page of the form shown in Table 6:

TABLE 6
ACTIVATION TYPE SELECTION PAGE

Please select the appropriate service:
(*) Live update of a previously registered Number File.
(*) Registration of a new Number File on your website.
[BACK] [NEXT]

Preferably the symbols shown in the form “(*)” in Table 6 above are displayed as radio buttons, or another graphic element, that can be selected by the user. When the user selects the first option (“Live update of a previously registered Number File”), as shown in blocks 214-216, the system activates the Crawler, which locates the user's Number File over the Internet, and updates the database 12, as described below. Thus, the “Live update” function provides a way for a user to force the system to locate a modified Number File and update itself with the new information. Alternatively, as described below in connection with the Crawler, the user may simply wait and the Crawler eventually will locate the modified file and update the database.

When the user selects the second option (“Registration of a new Number File on your website”), as shown in blocks 220 to 222, in response the system constructs and sends to the client 70 a Web page with which the user can enter payment information pertaining to the user and its Number Files in accordance with the amount calculated and actions taken at steps 203 and 203A. Payment steps of the activation process are an entirely optional part of the process, and other embodiments are contemplated that omit any payment mechanism including those relating to steps 203 and 203A. In the embodiments that do use a payment mechanism, the Web page contains fields that accept entry of payment information. For example, the fields enable entry of a credit card type, card number, expiration date, and cardholder name. The system receives the payment information values in block 224.

In block 226, the system prompts the user to enter the network address of the Number File to be activated, and a description of the Number File.

In block 228, the Registration Service 22 establishes an HTTP connection to the Web Server 60, requests and uploads a copy of the Number File 64. This step is carried out to verify that the Number File 64 is valid and is stored in the correct location. In block 230, the Number File 64 is parsed, and values identifying the network resource are extracted. In block 232, the system constructs a Web page that displays all the entries parsed from the current Number File 64, and sends the page to the client 70. Within the Web page, the system displays a prompting message, such as the following:

“The Number File that we have downloaded from your site contains the following entries. Please verify these entries are correct. Press NEXT to continue.

[BACK] [NEXT]”

As shown in block 234, the user reviews the entries, verifies that they are correct, and clicks on the NEXT function button. If any of the entries is not correct, the user clicks on the BACK function button, which provides access to the MODIFY function described herein.

In the preferred embodiment, the system then displays a Web page containing a written legal agreement governing payment of registration fees and resolution of disputes involving other issues such as legal issues, as shown in blocks 236-238. The agreement concludes with function buttons labeled ACCEPT and DECLINE. To accept the terms of the agreement and proceed with registration, the user clicks on the ACCEPT button. To decline the terms of the agreement and discontinue the activation process, the user clicks on the DECLINE button. Use of the legal agreement is entirely optional and embodiments that do not use such an agreement are contemplated and are within the scope of the invention.

The system then stores values parsed from the Number File 64 in the database 12 of the Registry 10, as shown in block 240.

For security reasons, the network address or URL of the Number File 64 must match the root directory of the Web server 60. This prevents redirection of telephone numbers to unauthorized different network addresses. It also prevents the owner of the Web server 60 from redirecting to that Web server any telephone number that he or she does not own.

In block 242, the Registration Service 22 notifies the Index Builder 32 that a new entry has been made in the database 12. Path 26 of FIG. 1B represents the notification. The notification includes information sufficient to identify the new entry in the database 12, for example, a row identifier (“rowid”) of a table in which the new entry is stored. In response, the Index Builder 32 carries out a live update of the Index Files 34, in the manner discussed further below.

Thus, the Number File 64 created by the user is activated and available for use by the Resolver 40.

In the preferred embodiment, the database 12 is available to receive queries from registered members of the system. As a result, a registered member can submit queries to the database 12 that request the database to display currently registered information about network resources or Web pages of other organizations. Accordingly, if another registered user succeeds in registering information that misrepresents the content of that user's network resources, the misrepresentation can be reported to the Registry for corrective action. Thus, in this manner, the formality of the registration process, and the open query capability of the database 12 enable the present system to avoid the deception that is possible through the improper use of metatags.

Modifying and Deleting Number File Information

After a Number File is created having one or more entries, the entries can be edited or deleted using the MLS File/Modify and MLS File/Delete functions shown in the top-level menu list.

When the user selects the MLS File/Modify function, the system reads the MLS file from the server associated with the user, and displays the contents of the file in a Web page having the form shown in Table 7.

TABLE 7
MLS FILE/MODIFY PAGE DISPLAY

The current list of MLS entries contained in your MLS file is shown
below. To edit an entry, select the appropriate word and press EDIT.
To delete an entry, select the appropriate word and press DELETE.
To add a new MLS entry, press ADD. Press NEXT when you are done
editing the MLS file.
[BACK] [EDIT] [DELETE] [ADD] [NEXT]

| | |
|---|---|
| Telephone Number: | 212-555-3000 |
| URL: | http://www.xyzcorp.com |
| Type: | Company |
| Language: | English |
| Region: | North America |
| Description: | the home page for widget manufacturer, XYZ Corp. |
| Selection: | |
| Telephone Number: | 212-555-1234 |
| URL: | http://www.acme.com |
| Type: | Company |
| Language: | English |
| Region: | Global |
| Description: | Home page for Acme Corp |
| Selection: | |

The page consists of a text instruction section, a set of editing function buttons, and a list of entries currently contained in the Number File. The text instruction section explains the functions carried out by the editing function buttons. In the preferred embodiment, the function buttons of this page operate on entire Number File entries rather than individual fields within each entry. For example, to edit an entry, a user selects the appropriate telephone number, such as “212-555-1235” and presses the EDIT function button. In response, the system displays an entry editing page that contains the selected entry. The user can enter modified text in fields of the entry editing page.

Similarly, to delete an entry, the user selects the appropriate word and presses the DELETE function button. In response, the system constructs a new Number File that contains all the prior entries except the entry selected for deletion.

To add a new entry to the currently displayed Number File, the user clicks on the ADD function button. In response, the system displays a page in the form of Table 3 discussed above in connection with creating a new Number File.

To apply changes made in the EDIT, DELETE, or ADD operations, the user presses the NEXT function button. Selecting the NEXT function button causes the system to construct a new Number File, preferably in the above-described XML format. The system emails the new Number File to the user in an appropriate explanatory message. For security reasons, the user is required to store the new Number File in a directory specified by the system, as in the case of creation of a new file. Crawler

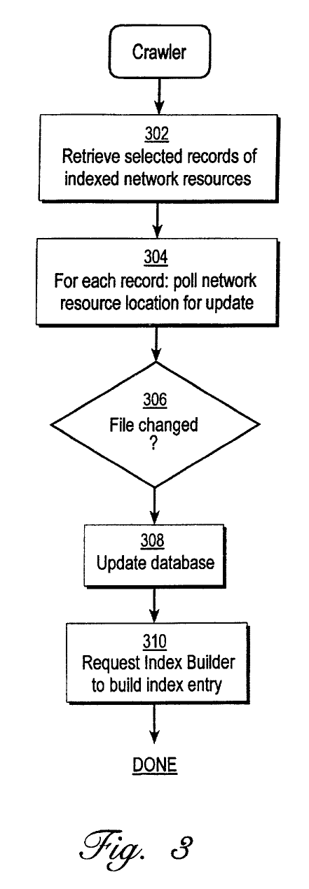

FIG. 3 is a flow diagram of an embodiment of a method that is preferably carried out by the Crawler 24. In the preferred embodiment, the system includes a Scheduler process that triggers activation and execution of the Crawler 24. For example, the Scheduler stores a schedule of events. An event states that the Crawler 24 should execute every twenty-four hours. Upon the occurrence of a scheduled event, the Scheduler launches the Crawler 24.

In block 302, the Crawler 24 reads the database 12 of the Registry 10 and retrieves one or more rows or records that identify network resources that are indexed in the Index Files 34. The protocol for selecting the rows or records is not critical, and several different schemes can be used. For example, the Crawler 24 can select all rows or records that have not been updated since the last time that the Crawler executed. Alternatively, the Crawler 24 can select all rows or records that have been created within a specified time frame or that are older than a particular number of days. In still another alternative, the Crawler 24 selects the least recently updated record. In a preferred embodiment, the system includes a mapping of telephone numbers to MLS file names and locations called the File Info table. The Crawler matches the selected rows to the File Info table and locates the network address, location or URL of the Number File associated with each telephone number, row or record.

For each of the selected rows or records, in block 304, the Crawler 24 polls the customer Web site that is represented by the row or record, searching for updates to the Number File 64 that is stored in association with that Web site. The polling step includes the steps of opening an HTTP connection to the Web site, requesting and receiving a copy of the Number File. The Crawler 24 parses the Number File, using an XML parser, to identify telephone number entries, and values within each telephone number entry, that specify the telephone number, network address, and descriptive information relating to network resources. An XML parser is commercially available from Microsoft® Corporation.

For each entry in the Number File, as shown in block 306, the Crawler 24 tests whether the entry matches a row or record in the database 12. Thus, the Crawler 24 determines whether the contents of the Number File are different from entries in the database 12. If so, as shown in block 308, then the Crawler 24 updates the database 12, and requests the Index Builder to rebuild the index entry associated with the updated row or record in the database 12.

In this way, the Crawler 24 polls Web sites on the Internet 50 to locate customer sites that have updates. Because the Number Files are distributed across the network at numerous customer sites, each customer has the freedom and flexibility to modify its Number File at any desired time. The customer need not notify the telephone number system, because the Crawler 24 will eventually locate each change and update the database 12 accordingly. Thus, the Librarian 20 automatically monitors changes to Number Files distributed across the network, and periodically updates the Registry 10 with the change. Advantageously, customers or end users are not involved in updating the database 12; the Crawler 24 updates the database automatically.

In the preferred embodiment, a customer can instruct the Librarian 20 to immediately execute the Crawler 24 with respect to a specific Web site. In this way, changes to a particular Number File are immediately identified and loaded into the database. The customer activates immediate execution of the Crawler 24 by selecting the Live Update option from the top-level menu. In the preferred embodiment, the system also carries out, once weekly, a comprehensive update of the Index Files 34 based on the contents of the database 12. In this way, at least weekly, the Index Files 34 are rebuilt based on the current contents of the database 12.

In an alternate embodiment, the Crawler 24 also validates each of the network resource locations that are identified in each Number File. For example, the Crawler 24 attempts to connect to and load each network resource that is identified in a Number File entry. If an error occurs, an appropriate email message is composed and sent to the contact person of the organization that registered the Number File. The email message advises the contact person that the network resource location in the Number File is invalid.

Index Builder

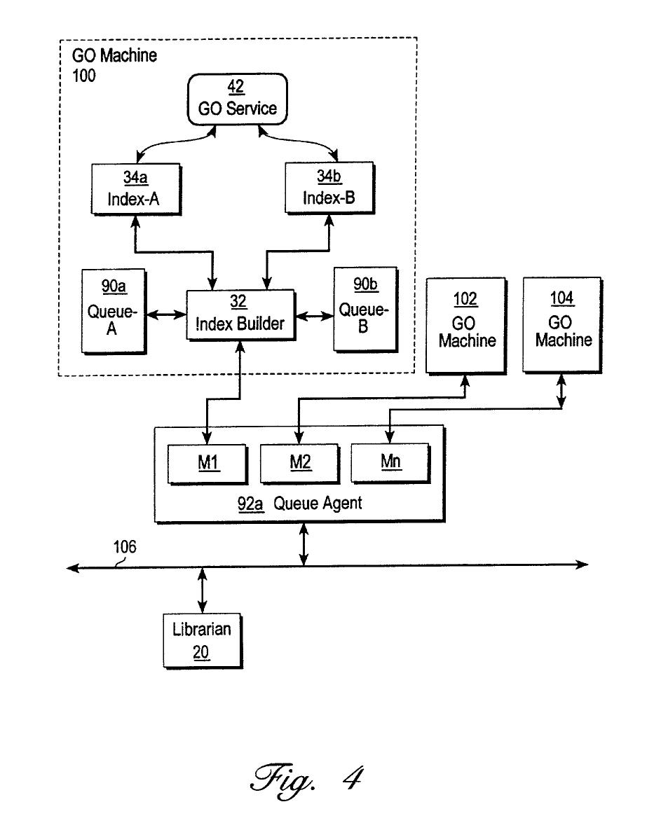

The Index 30 comprises an Index Builder 32 and Index Files 34. The Index Builder 32 is a software program or process that operates in two modes. In the first mode, a Reconstructor process of the Index Builder 32 periodically polls the database 12, discovers changes to the database, and indexes the changed telephone number records in the Index Files 34. In a second mode, the Index Builder 32 updates the Index Files 34 in real time, based upon a queue of requests to update the indexes. FIG. 4 is a block diagram of a preferred embodiment of the Index Builder 32. Computers labeled GO Machines 100, 102, 104 each run an instance of the Index Builder 32. Each GO Machine 100, 102, 104 is associated with a network interface process M1, M2, Mn of a Queue Agent 92a. The Queue Agent 92a is coupled to a network 106, such as a local area network, and receives requests to build index entries from the Librarian 20. The Queue Agent 92a propagates a copy of each request to one of the network interfaces M1, M2, Mn, which forwards the request to its associated GO Machine 100, 102, or 104. This architecture is highly responsive to external queries, and is fault-tolerant.

Within each GO Machine, the Index Builder 32 is coupled to a pair of queues 90a, 90b and a pair of indexes 34a, 34b. The GO Service 42 can access either of the indexes 34a, 34b, but always accesses only one of the indexes at a time. The Resolver 40 is omitted from FIG. 4 for clarity, but it should be understood that the GO Service 42 accesses each index 34a, 34b through a Resolver 40 process.

It is important for the GO Service 42 to be in constant communication with one index or the other. Accordingly, using the architecture shown in FIG. 4, the Index Builder builds the indexes using the following process. The GO Service is placed in contact with index 34b and instructed to communicate telephone number resolution requests only to index 34b. As index build requests arrive from the Queue Agent 92a at the Index Builder 32, the Index Builder 32 adds the requests to both of the queues 90a, 90b. When one of the queues is sufficiently full, for example, queue 90a, the Index Builder 32 sequentially removes entries from the queue, in first-in-first-out order, and updates the index 34a with each queue entry. Concurrently, if any new index build requests are received, they are routed to both of the queues. When the queue 90a is empty and the index 34a is fully updated, the Index Builder 32 instructs the GO Service 42 to communicate telephone number resolution requests only to index 34a. The Index Builder 32 then removes entries only from queue 90b and updates only index 34b from that queue. Thus, the Index Builder 32 can add index entries to either of the queues 90a, 90b, but always updates only one index at a time using the contents of only one of the queues at a time. The queue with which the Index Builder 32 communicates is always the opposite or complement of the indexes 34a, 34b with which the GO Service 42 is currently communicating. In this way, the GO Service 42 constantly communicates with an index, and the Index Builder 32 can update the index in real time without disrupting telephone number resolution operations.

Preferably, the index build requests comprise an identifier, called a FileId, of a file or row that is mapped in the File Info table described above. The Index Builder 32 looks up the FileID in the File Info table and retrieves all entries in the database that match the FileID. Each database entry includes a unique identifier that is associated with a network resource that is described in the database entry. The unique identifiers are generated using a sequence facility of the database server. Based on the unique identifier, for database entry that matches the FileID, the Index Builder retrieves a matching index entry. The information in the index entry is compared to the information in the build request. If the information in the build request is different, the index entry is updated. If the information in the build request indicates that the associated network resource has become inactive or unavailable in the network, the index entry is deleted.

To provide scalability, reliability, and rapid response, each of the GO Machines 100, 102, 104 has a similar configuration and operates in parallel. Although three GO Machines 100, 102, 104 are shown in FIG. 4 as an example, any number of GO Machines can be used in the system. In the preferred embodiment, a Scheduler process determines when the Index Builder 32 executes.

Resolver

Generally, the Resolver 40 functions as a runtime query interface to the metadata that is stored in the Registry 10. The Resolver 40 functions to receive telephone number requests from services 42, 44, 46, query the index 30 to identify network addresses corresponding to the telephone number requests, and respond to the services with the network addresses. The Resolver 40 is structured to respond rapidly to query operations and to service millions of requests per day. To maximize response time and ensure scalability, the Resolver 40 does not directly access the database 12 of the Registry 10 in responding to queries. Instead, the Resolver communicates with the Index 34 that is stored in fast main memory.

In the preferred embodiment, the Resolver 40 operates in any number of multiple instances R1, R2, Rn, each of which is associated with a service 42, 44, 46 that is making a request to the Resolver. The services 42, 44, 46 communicate with Resolver instances R1, R2, Rn using HTTP connections. Further, it is preferred to operate the computer hardware on which the Resolver 40 runs in a triple-redundancy configuration. This configuration provides rapid response to the requesting services 42, 44, 46 and provides reliability. Each instance R1, R2, Rn is implemented as an instance of a Web application that implements the Resolver. The services 42, 44, 46 communicate with Resolver instances R1, R2, Rn using HTTP connections.

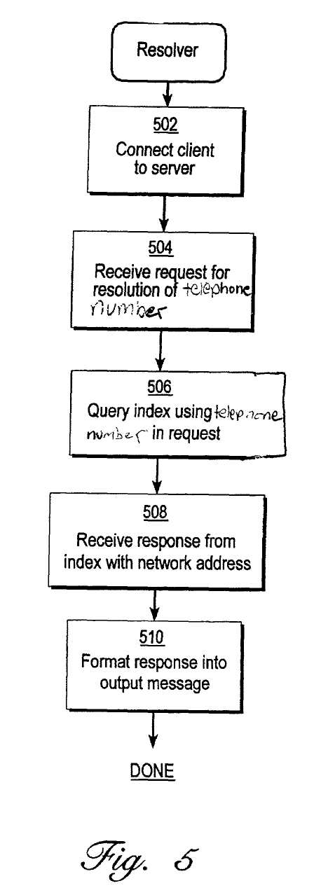

In one embodiment, an instance of the Resolver 40 is implemented as a dynamically linked library (DLL) that is integrated into the services 42, 44, 46. In the preferred embodiment each instance of the Resolver 40 is a detached, separate process or program that operates according to the method shown in FIG. 5. The Resolver 40 is implemented with one or more APIs that allow the development of services that use the Resolver, such as “yellow pages” and search services.

As shown in blocks 502-504, an external Web client, server or browser, such as the client 70, accesses the Resolver 40. In one embodiment, the client 70 connects to the Resolver 40 using an HTTP connection. In block 502, the client 70 establishes an HTTP connection to the Resolver 40. In block 504, the client 70 provides a URL to the Resolver that requests the network address corresponding to a particular telephone number. For example, the URL is in the form http://www.resolver.com/resolve? tn=TELRPHONE NUMBER. In a URL of this form, “http://” identifies the URL as an HTTP request, www.resolver.com is the server domain, and “resolve” is the name of a program running on that server domain that implements the resolver. The statement “tn=TELEPHONE NUMBER” passes the value “TELEPHONE NUMBER” to a parameter “rntn” that is recognized by the resolver. In instances where the telephone numbers are stored with accompanying area and country codes, the client browser is preferably programmed to add the country and area code to a telephone number that is entered by the user without one or both of the codes. This information may derived from settings in the user's Window's operating system.

In another embodiment, the client 70 connects to one of the services 42, 44, 46 associated with an instance of the Resolver 40. The services 42, 44, 46 communicate with the client 70 to request and receive a telephone number.

Thus, in one of these ways, the Resolver 40 receives a telephone number requested by the client 70. In response, the Resolver 40 constructs a Qualifier object in main memory that contains the telephone number. In block 506, the Resolver connects to the Index 30 and submits a query requesting the network address or URL that corresponds to the telephone number in the request from the client 70. In the preferred embodiment, the query is submitted by sending a message containing the Qualifier object to an Index Store object. The Index Store object encapsulates or provides an abstract representation of the Index 30. The Index Store object executes an index query.

In block 508, the Resolver 40 receives a response from the Index 30 that contains the network address or URL that corresponds to the telephone number in the request from the client 70. In the preferred embodiment, the Index Store object returns an Entry Set object to the Resolver 40. The Entry Set object contains or references a set of one or more entries from the Index 30 that correspond to the requested telephone number. Preferably, an entry Set object is configured to supply the location or URL of a network resource described in an entry of the object.

Use of The Entry Set object allows operation when only a part of a telephone number is entered. This is particularly useful when a user of the present system knows only a part of the telephone number for which information is sought. As an example, a user who knows only the last four digits of a telephone number may enter “3421”. The Entry Set object will contain all telephone number entries that end with the numbers “3421”, e.g., “212-324-3421”, “213-247-3421” and “702-397-3421” and the user may then select the number or corresponding resource that is believed to be the desired resource.

The Index Store object also has logic for ordering entries in the Entry Set object based on a function of past usage. When the Entry Set object has just one entry, ordering is not needed. When the Entry Set object has more than one entry, the entries may be in using any desired method to indicate any desired ordering preference.

In block 510, the Resolver 40 formats the response of the index into an output message. In a preferred embodiment, the Resolver 40 constructs an XML file containing the information in the response from the Index 30. In the preferred embodiment, the services 42, 44, 46 each are provided with an XML parser that can convert the XML file produced by the Resolver 40 into text or other information in a format that is usable by the client 70. Also in the preferred embodiment, each entry referenced in the Entry Set object contains a usage value that indicates the number of times that the entry has been resolved. The usage values may be used to order the entries when they are displayed or otherwise used by one of the Services 42-46.

Preferably, after each telephone number resolution, the Resolver 40 writes an entry in a log file 84 that describes the telephone number, the total number of times it has been resolved in the past including the current resolution, the IP address and domain name of the client or server that requested the current resolution, and the time at which the current resolution occurred.

In the preferred embodiment, the Index 30 and the Resolver 40 execute on the same physical computer, and the Index Files 34 are stored in main memory of that computer. This configuration improves response time of the Resolver 40 by providing it with high-speed access to the Index 30. It is contemplated that the Resolver 40 will respond to several tens of millions of telephone number resolution requests per day. Also in the preferred embodiment, the Index 30 and the Resolver 40 are implemented as a plurality of Component Object Model (COM) programmatic objects that communicate with the AltaVista runtime library using AltaVista's API. The AltaVista runtime library is commercially available for license from Digital Equipment Corporation in the form of the AltaVista Software Development Kit (SDK).

In an alternate embodiment, the Resolver 40 is capable of distinguishing among network addresses that refer to resources located on the Internet, an internal business network or “intranet”, and an externally accessible internal business network or “extranet”. In an intranet environment, the Resolver 40 accesses a Registry 10 that is located within the organization that owns and operates the Resolver. The Registry 10 stores resource information that identifies intranet resources. This is particularly applicable for businesses having PBX-based telephone systems utilizing internal four or five digit extension dialing. The Resolver 40 resolves the telephone number or extension entered by the user into the locations of intranet resources, and navigates the user to the resources.

Services

The services 42, 44, 46 can be implemented in several variations. In one embodiment, the GO service 42 is a computer program that is installed into or attached to the browser 74 of the client 70. For example, the GO service 42 is installed into the client 70 as a plug-in to the browser 74. The user downloads the GO service 42 from a central distribution site and stores the service on the client 70. The user executes an installation program that installs the service into the browser 74. Once installed, the GO service 42 intercepts telephone numbers entered by the user into the browser 74 and resolves the telephone numbers into network addresses that are usable by the browser 74.

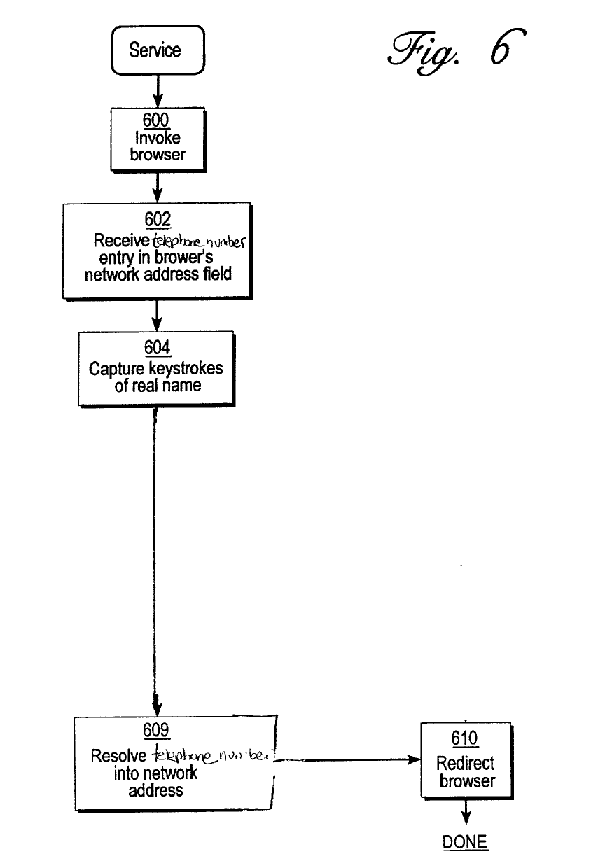

FIG. 6 is a block diagram of a method of operating the GO service 42 in this configuration. In block 600, the user invokes or initiates execution of the browser 74. The browser 74 has a URL data entry field into which a user customarily types a network address of a document to be retrieved and displayed by the browser, such as a URL. In block 602, the user enters a telephone number into the network address data entry field. In block 604, the GO service 42 captures all keystrokes that are typed by a user into the network address data entry field of the browser 74 and thereby receives the telephone number entered by the user.

Control is next passed to block 609. In block 609, the service 42 requests the Resolver 40 to resolve the telephone number received at the browser into a network address. For example, the service 42 constructs a URL that references a pre-determined location of the system that implements the Resolver 40. The URL contains, as a parameter to be passed to the Resolver 40, the telephone number received at the browser. The service 42 opens an HTTP connection from the client 70 to the Resolver 40 using the URL that contains the telephone number. The Resolver 40 extracts the value of the telephone number from the URL, and carries out the resolution process described above. The Resolver 40 then returns the network resource location values in an HTTP message to the browser 74.

If a corresponding network resource location value is received from the Resolver 40, in block 610, the GO service 42 redirects the browser 74 to the network address found by the Resolver 40. For example, the service 42 extracts the network resource location value from the HTTP message received from the Resolver 40, and passes the value to functions of the browser 74 that can load and display Web pages. The browser 74 then loads and displays the file or page located at the network address in conventional manner. Alternatively, if more than one network resource location value is received from the Resolver 40 in response to the Resolver 40 receiving only a partial telephone number, then in block 610 the service displays a list of the network resource location values. The results are displayed in an order, from most prior resolutions to least prior resolutions, based on the resolution values compiled and stored by the Statistics Service 82. In another variation, the service returns to the client 70 an HTTP response containing an XML in which the results of the query are stored.

In an alternate embodiment, the GO service 42 is implemented as a Web application that runs on a dedicated Web server. To locate a network resource, the client 70 connects to the GO Web server using a predetermined network address or URL. In response, the Web application of the GO service 42 displays a Web page comprising a form with a data entry field. The end user types the telephone number of a network resource into the data entry field. The GO server 42 locates the network resource in the manner described above.

In another alternate embodiment, the GO service 42 is linked to a button or panel that is embedded in a Web page of an external Web server. The button or panel is anchored to a network address or URL that invokes the GO service 42 when the button or panel is selected by a user viewing the external Web server. This configuration provides a way to enter telephone numbers that does not require use of a browser.

In yet another alternate embodiment, the GO Service 42 includes a mechanism to detect and respond to the language being used by the client 70 that contacts and provides a query to the GO Service, defining the country code this way. Assume the computer that is running the GO Service 42 operates using UTF-8 character set encoding and the English language, whereas the client 70 is using the Japanese language and a different character set encoding. When the GO Service 42 sends a Web page to the client 70 that contains the telephone number entry form, the Web page includes a hidden field that stores a pre-determined text string. The client 70 receives the Web page, and its browser or operating system converts the Web page to the character set that it uses. The user of the client 70 enters a telephone number into the Web page and submits it to the GO Service 42. The GO Service 42 receives the Web page, extracts the value of the hidden field, and compares the hidden field value to a table or mapping of hidden field values to character set encodings and languages The GO Service 42 retrieves the corresponding character set encoding and language. Based on the language (country codes)., the GO Service 42 selects a resource having a matching Language value in the metadata section 906 of the resource. In this way, the system transparently determines the language of the client that originates a query, and supplies a resource that is appropriate to that language.

In another alternate embodiment, the GO Service 42 and the Resolver 40 use the values of the metadata in the Number File 64 associated with resources to respond to advanced queries. For example, assume that United Airlines registers a Number File 64 that describes resources in several different languages such as English, French, and Japanese. A user desires to locate a Web site affiliated with United Airlines that is located in France or prepared in the French language. The user enters the telephone number for reservations for United Airlines in the United states appended with the word “France” as follows: “1-800-241-6522 France,” into the GO Service 42. The Resolver 40 attempts to match the entry to the Description, Region, and Language fields of the metadata section 906 associated with the United Airlines Number File 64. The Resolver 40 and the Go Service 42 redirect the user's browser to a United Airlines site presented in French.

In an alternate embodiment, when the GO Service 42 is implemented as a browser plug-in installed in the client 70, the GO Service provides character encoding information to the Resolver 40. To obtain the character encoding currently used on the client 70, the GO Service 42 calls an operating system function of the operating system that runs on the client 70. The GO Service 42 attaches the character encoding information to the URL that is used to return the user's query to the Resolver 40. In this way, the Resolver receives information indicating the language and character set currently used by the client 70, and can respond with a network resource that is appropriate to that language.

In another alternate embodiment, the computer system further includes a microphone coupled to an analog-to-digital converter. The analog-to-digital converter is coupled through an appropriate interface to the bus of the computer system. Under control of driver software or another appropriate application program, the analog-to-digital converter receives an analog audio input signal from the microphone and converts the signal to a digital representation of the signal. The driver or application program receives the digital representation and converts it into a phoneme, string of words, keyword, or command for the GO Service 42. The converted digital representation is used by the GO Service 42 as input, as a substitute for input from the keyboard or mouse. Thus, a user can view the user interface display 1000 and speak words into the microphone to command the GO Service 42 to locate a particular network resource. In this way, the user can navigate the Web using spoken words (numbers).

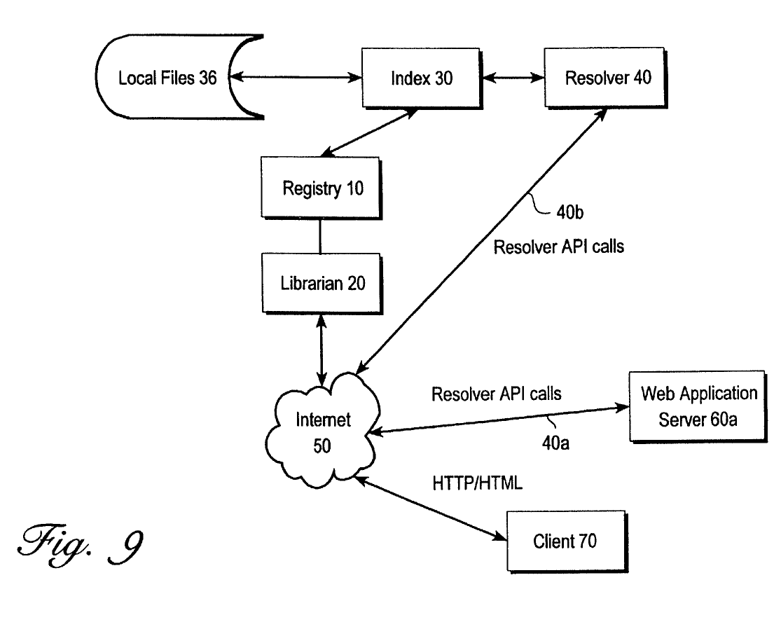

Another alternate embodiment is shown in FIG. 9. A Service is implemented in the form of a Web server or middle-tier Web application server 60a. The Web application server 60a communicates to the client 70 using HTTP messages through the Internet 50. The Web application server 60a includes a Common Gateway Interface (CGI) script processor, an application server such as Netscape's Kiva, Microsoft's Active Server, or Apple's WebObjects.RTM.. An application program running on the Web application server 60a communicates with the Resolver 40 through the Internet 50 over paths 40a, 40b using CGI scripts to generate HTTP requests and responses. The Web application server 60a uses calls to functions provided by the API of the Resolver 40 to communicate along paths 40a, 40b. Using this structure, the Web application server 60a issues requests containing queries to the Resolver 40. In response, the Resolver 40 evaluates the query, queries the Index 30, and creates a set of metadata for all Index entries reflecting Web pages that match the query. The set of metadata is packaged as an XML file and delivered to the Web application server 60a by the Resolver 40. The Web application server 60a has an XML parser that can parse the XML code in the XML file. Based on the parsed XML code, the Web application server 60a creates one or more HTML documents and delivers the HTML documents to the client 70. The client 70 displays the HTML documents to the end user.

Statistics Service

As described above in connection with the Resolver 40, each time a telephone number resolution is carried out by the Resolver, it writes a log file entry. The system includes a Statistics Service 82 that is responsible for reading the log file and loading information from the log file into the Index Files 34.

In the preferred embodiment, the Statistics Service 82 operates periodically on a scheduled basis. The Statistics Service 82 reads each record of the log file and constructs an index object based on the information in the log file. The Statistics Service 82 then sends a message to the Index Builder 32 that requests the Index Builder to persistently store the values in the Index Files 34. In response, the Index Builder 32 stores the values in the Index Files 34.

The top-level menu page of the system has hyperlinks that enable the user to access statistics and billing functions.

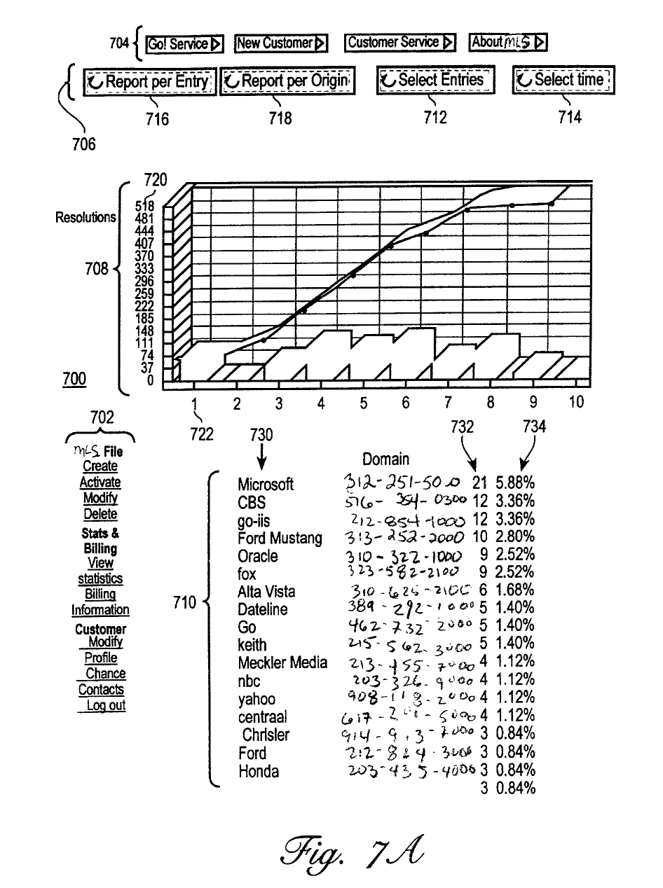

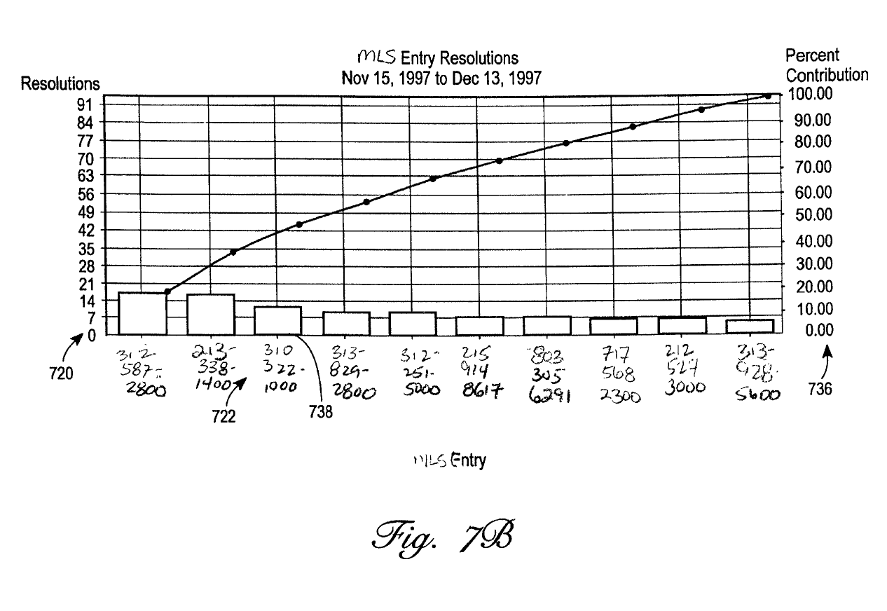

When the Statistics & Billing/Statistics option is selected, the system generates a Web page 700 in the form shown in FIG. 7A. The Web page 700 has a list 702 of top-level options. A set of function buttons 704 enable the user to establish other global functions such as resolving an address, entering new customer information, obtaining customer service, and learning more information about the telephone number system.

Report function buttons 706 enable the user to access report generation functions of the system. In an embodiment, the report function buttons 706 include a Select Entries button 712, a Select Time button 714, a Report per Entry button 716, and a Report per Origin button 718.

The Select Entries button 712 is used to identify a range of entries within a Number File for which statistics are to be generated. When the user selects the Select Entries button 712, the system reads the Number File on the server having an IP address matching the IP address of the user's current domain. The system parses the Number File and displays a list of all the telephone numbers in a new Web page that is sent to the client 70. The Web page displays a radio button adjacent to each of the telephone numbers in the list. By clicking on the radio button and then submitting the Web page to the system, the system will provide statistical information for all the selected telephone numbers in all reports that are generated later.

The Select Time button 714 is used to identify a time frame for which statistics are to be generated. When the user selects the Select Time button 714, the system generates a new Web page and sends it to the client 70. The Web page includes a form into which the user enters a starting date and an ending date. When the user submits the filled-in page to the system, the system receives and stores the date values. When reports are generated thereafter, the reports will contain statistical information for resolutions of telephone numbers that occurred within the specified dates.

The Report per Entry button 716 is used to generate a report and graph showing all telephone number resolutions that have occurred for each telephone number entry defined in the current Number File. When the Report per Entry button 716 is selected, the system reads statistical information that is stored in the statistical tables of the database 12 for each of the telephone numbers that are defined in the current Number File. The system generates a graph and a chart of the statistical information, and generates a Web page containing the graph and chart.

FIG. 7A is an example of a Web page generated in this manner. The graph pane 708 shows an exemplary bar graph. Each bar in the bar graph represents a telephone number defined in the current Number File. The vertical axis 720 identifies the number (in thousands) of resolutions of each telephone number. The horizontal axis 722 identifies each Number for which statistics information is reported. The statistics pane 710 comprises a description column 730 with information taken from the Description field from the Number File, a quantity of resolutions column 732, and a percentage column 734. The description column 730 lists each telephone number and associated Description that is defined in the current Number File. The quantity of resolutions column 732 gives the number of resolutions of that telephone number that have occurred within the currently defined time period. The percentage column 734 indicates, for each telephone number, the percentage of total resolutions represented by the resolutions of that telephone number.

FIG. 7B is an example of another type of graph generated by the statistics service. The vertical axis 720 shows the number of resolutions of each telephone number. The horizontal axis 722 comprises a plurality of bars 738, each bar associated with a telephone number. The bar represents the number of resolutions of that telephone number. A second vertical axis 736 displays a number indicating the percentage of total resolutions carried out by the system that is represented by each telephone number shown in the horizontal axis 722.

In an embodiment, a fee is charged by the owner of the telephone number system to end users or customers who register telephone numbers in the Registry 10. The Librarian 20 records a charge against the account of the user when a new entry is submitted to the system using the Registration Service 22. In another embodiment, end users or customers who register telephone numbers in the Registry 10 pay a fee to the owner of the telephone number system for each resolution executed by the Resolver 40 in response to a third-party request. The Resolver 40 records a charge against the account of the user when each resolution is completed. In these embodiments, the account information and charges are logged and accumulated in tables of the database 12. Periodically, an external billing application reads the charge and account tables of the database 12 and generates invoices that are sent to the user. The Statistics & Billing/Billing Information option of the top-level option list 702 enables the user track and monitor, in real time, the user's credits and payments for registered telephone number entries, as well as resolution fees. When the Billing Information function is selected, the system reads the charge and account tables of the database 12 and generates a report, in a Web page, summarizing the charges to the customer. The Web page is delivered to the client 70 and displayed by it.

Hardware Overview

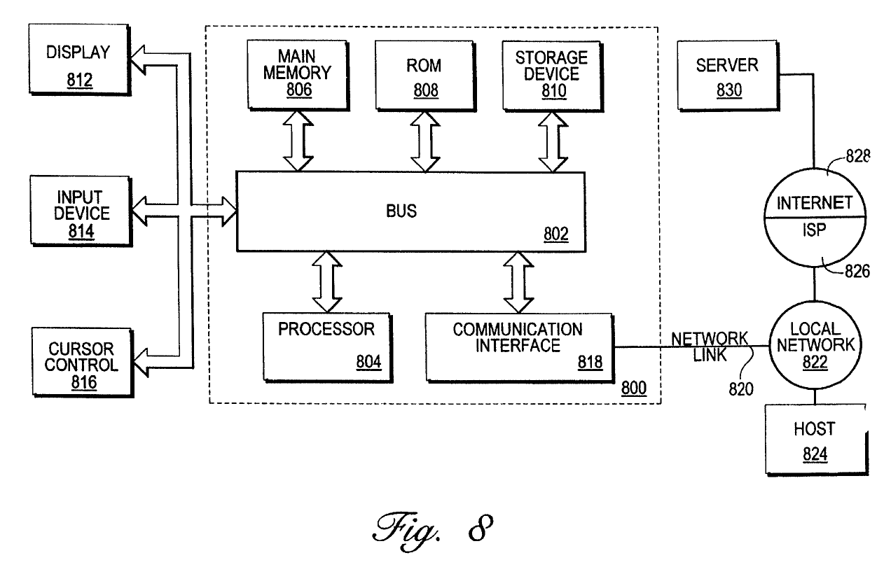

FIG. 8 is a block diagram that illustrates a computer system 800 upon which an embodiment of the invention may be implemented. The system of FIG. 8 is directed to the above-described embodiments for the resolution of Web page resources using telephone numbers. One skilled in the art will appreciate that the system of FIG. 8 can be modified appropriately using known methods and components to accomplish resolution of other resources as described above, e.g., mobile telephones, PDAs, etc.

Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to the use of computer system 800 for providing a telephone number-based network resource locating system. According to one embodiment of the invention, network resource locating is provided by computer system 800 in response to processor 804 executing one or more sequences of one or more instructions contained in main memory 806. Such instructions may be read into main memory 806 from another computer-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector coupled to bus 802 can receive the data carried in the infra-red signal and place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818. In accordance with the invention, one such downloaded application provides for a language-independent network resource naming system as described herein.

The received code may be executed by processor 804 as it is received, and/or stored in storage device 810, or other non-volatile storage for later execution. In this manner, computer system 800 may obtain application code in the form of a carrier wave.

Variations; Advantages

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

We claim:

1. A method of navigating, based upon a first telephone number, to a resource that is stored in a network and identified by a location identifier, comprising the steps of:
storing the first telephone number relating to the resource and an associated location identifier of the resource;
receiving a request to locate the resource containing, said request including the first telephone number;
retrieving the location identifier associated with the first telephone number; and
delivering the resource to the user using the location identifier.

2. The method recited in claim 1, further comprising the steps of:
storing at least a second telephone number associated with the resource;
receiving requests to locate the resource based on one of the first and second telephone numbers;
retrieving the location identifier associated with the said one of the first and second telephone numbers; and
retrieving and displaying the resource using the location identifier.

3. The method recited in claim 2, further comprising the steps of:
storing the first and second telephone numbers in association with the location identifier, and in a number file in a storage device associated with the resource.

4. The method recited in claim 3, further comprising the steps of:
retrieving the number file;
parsing the number file;
building an index entry based on the values parsed from the number file; and
storing the index entry in an index that is stored apart from the storage device.

5. The method recited in claim 4, further comprising the steps of:
sending the number file over the network to a client associated with the resource;
storing the number file in a server storage device of a server associated with the client.

6. The method recited in claim 5, further comprising the steps of:
periodically polling the number file on the server associated with the client;
testing whether one of the telephone numbers stored in the number file matches a third
telephone number stored in a database indexed by the index; and
updating the database when changes are detected in the number file.

7. The method recited in claim 6, further comprising the step of:
synchronizing the index to the database.

8. The method recited in claim 1, wherein the step of storing the first telephone number comprises the steps of:
receiving a client identifier of a client associated with the resource;
generating a set of metadata that describes the resource, the location identifier, and the client identifier; and
storing the set of metadata in a persistent storage device associated with the client.

9. The method recited in claim 8, further comprising the steps of:
assigning a randomly generated name to the set of metadata.

10. The method recited in claim 9, further comprising the steps of: instructing the client to store the metadata in a particular authorized location in the persistent storage device.

11. The method recited in claim 9, further comprising the steps of:
registering the set of metadata and the randomly generated name in a database.

12. A method of locating a network resource in a network, comprising the steps of:
connecting a client over the network to an index of mappings of telephone numbers to network resource locations;
submitting a request from the client to the index to obtain one or more network resource locations that map to one of said telephone numbers;
querying the index for one or more network resource locations;
receiving from the index the network resource locations that map to the telephone number; and
delivering the network resource from the one or more network resource locations to the client.

13. The method of claim 12, wherein the step of connecting a client includes the step of connecting the client to the index using a browser coupled to a resolution process, and further comprising the step of:
redirecting the browser to the network resource located at the one of the network resource locations.

14. A system comprising:
a client that executes a World Wide Web browser,
a server for storing a network resource,
a database for storing a mapping of a plurality of telephone numbers related to the network resource to a Uniform Resource Locator of the network resource, and
a network for interconnecting the browser, the server, and the database, the system operating to:
receive a telephone number of the network resource in the browser;
obtain, from the database, the Uniform Resource Locator of the network resource that corresponds to the telephone number received in the browser;
redirect the browser to locate the network resource at the Uniform Resource Locator; and
display the network resource at the client.

15. A computer data signal embodied in a carrier wave, the computer data signal carrying one or more sequences of instructions for naming and locating network resources, wherein execution of the one or more sequences of instructions by one or more processors causes the one or more processors to perform the steps of:
storing a first telephone number associated with the resource and a location identifier of the resource;
receiving a request to locate the resource, the request including the first telephone number;
retrieving the location identifier associated with the first telephone number; and
delivering the resource to a client using the location identifier.

16. The computer data signal recited in claim 15, wherein execution of the one or more sequences of instructions by one or more processors causes the one or more processors to perform the further steps of:
storing at least a second telephone number associated with the location identifier;
receiving requests to locate the resource based on one of the first and second telephone numbers;
retrieving the location identifier associated with one of the first and second telephone numbers; and
retrieving and displaying the resource using the location identifier.

17. The computer data signal recited in claim 16, wherein execution of the one or more sequences of instructions by one or more processors causes the one or more processors to perform the further steps of:
storing the first and second telephone numbers in association with the location identifier, and in a number file in a storage device associated with the resource.

18. The computer data signal recited in claim 17, wherein execution of the one or more sequences of instructions by one or more processors causes the one or more processors to perform the further steps of:
retrieving the number file;
parsing the number file;
building an index entry based on the values parsed from the number file; and
storing the index entry in an index that is stored apart from the storage device.

19. The computer data signal recited in claim 18, wherein execution of the one or more sequences of instructions by one or more processors causes the one or more processors to perform the further steps of:
sending the number file over the network to a client associated with the resource;
storing the number file in a server storage device of a server associated with the client.

20. The computer data signal recited in claim 19, wherein execution of the one or more sequences of instructions by one or more processors causes the one or more processors to perform the further steps of:
periodically polling the number file on the server associated with the client;
testing whether one of the telephone numbers stored in the number file matches a third telephone number stored in a database indexed by the index; and
updating the database when changes are detected in the number file.

21. The computer data signal recited in claim 20, wherein execution of the one or more sequences of instructions by one or more processors causes the one or more processors to perform the further steps of:
synchronizing the index to the database.

22. The computer data signal recited in claim 15, wherein execution of the one or more sequences of instructions by one or more processors causes the one or more processors to perform the step of storing a first telephone number by:
receiving a client identifier of a client associated with the resource;
generating a set of metadata that describes the resource, the location identifier, and the client identifier; and
storing the set of metadata in a persistent storage device associated with the client.

23. The computer data signal recited in claim 22, wherein execution of the one or more sequences of instructions by one or more processors causes the one or more processors to perform the further steps of:
assigning a randomly generated name to the set of metadata.

24. The computer data signal recited in claim 23, wherein execution of the one or more sequences of instructions by one or more processors causes the one or more processors to perform the further steps of:
instructing the client to store the metadata in a particular authorized location in the persistent storage device.

25. The computer data signal recited in claim 24, wherein execution of the one or more sequences of instructions by one or more processors causes the one or more processors to perform the further steps of:
registering the set of metadata and the randomly generated name in a database.

26. A computer apparatus comprising:
a processor; and
a memory coupled to the processor, the memory containing one or more sequences of instructions for naming and locating network resources, wherein execution of the one or more sequences of instructions by the processor causes the processor to perform the steps of:
storing a first telephone number relating to the resource in association with the location identifier of the resource;
receiving a request to locate the resource, the request including the first telephone number;
retrieving the location identifier associated with the first telephone number; and
delivering the resource to a client using the location identifier.

27. The computer apparatus recited in claim 26, wherein execution of the one or more sequences of instructions by one or more processors causes the one or more processors to perform the further steps of:
storing at least a second telephone number for the resource, in association with the location identifier;
receiving requests to locate the resource based on one of the first and second telephone numbers;
retrieving the location identifier associated with the one of the first and second telephone number; and
retrieving and displaying the resource using the location identifier.

28. The computer apparatus recited in claim 27, wherein execution of the one or more sequences of instructions by one or more processors causes the one or more processors to perform the further steps of:
storing the first and second telephone numbers in association with the location identifier, and in a number file in a storage device associated with the resource.

29. The computer apparatus recited in claim 28, wherein execution of the one or more sequences of instructions by one or more processors causes the one or more processors to perform the further steps of:
retrieving the number file;
parsing the number file;
building an index entry based on the values parsed from the number file; and storing the index entry in an index that is stored apart from the storage device.

30. The computer apparatus recited in claim 29, wherein execution of the one or more sequences of instructions by one or more processors causes the one or more processors to perform the further steps of:
sending the number file over the network to a client associated with the resource;
storing the number file in a server storage device of a server associated with the client.

31. The computer apparatus recited in claim 30, wherein execution of the one or more sequences of instructions by one or more processors causes the one or more processors to perform the further steps of:
periodically polling the number file on the server associated with the client;
testing whether one of the telephone numbers stored in the number file matches a third telephone number stored in a database indexed by the index; and updating the database when changes are detected in the number file.

32. The computer apparatus recited in claim 31, wherein execution of the one or more sequences of instructions by one or more processors causes the one or more processors to perform the further step of:
synchronizing the index to the database.

33. The computer apparatus recited in claim 27, wherein execution of the one or more sequences of instructions by one or more processors causes the one or more processors to perform the step of storing a first telephone number by:
receiving a client identifier of a client associated with the resource;
generating a set of metadata that describes the resource, the location identifier, and the client identifier; and
storing the set of metadata in a persistent storage device associated with the client.

34. The computer apparatus recited in claim 33, wherein execution of the one or more sequences of instructions by one or more processors causes the one or more processors to perform the further steps of:
assigning a randomly generated name to the set of metadata.

35. The computer apparatus recited in claim 34, wherein execution of the one or more sequences of instructions by one or more processors causes the one or more processors to perform the further steps of:
instructing the client to store the metadata in a particular authorized location in the persistent storage device.

36. The computer apparatus recited in claim 35, wherein execution of the one or more sequences of instructions by one or more processors causes the one or more processors to perform the further steps of:
registering the set of metadata and the randomly generated name in a database.

37. A computer-readable medium carrying one or more sequences of instructions for naming and locating network resources, wherein execution of the one or more sequences of instructions by one or more processors causes the one or more processors to perform the steps of:
storing a first telephone number of the resource in association with the location identifier of the resource;
receiving a request to locate the resource, the request including the first telephone number;
retrieving the location identifier associated with the first telephone number; and
delivering the resource to a client using the location identifier.

38. The computer-readable medium recited in claim 37, wherein execution of the one or more sequences of instructions by one or more processors causes the one or more processors to perform the further steps of:
storing at least a second telephone number for the resource in association with the location identifier;
receiving requests to locate the resource based on the first and second telephone numbers;
retrieving the location identifier associated with the first and second telephone numbers; and
retrieving and displaying the resource using the location identifier.

39. The computer-readable medium recited in claim 38, wherein execution of the one or more sequences of instructions by one or more processors causes the one or more processors to perform the further steps of:
storing the first and second telephone numbers in association with the location identifier, and in a number file in a storage device associated with the resource.

40. The computer-readable medium recited in claim 39, wherein execution of the one or more sequences of instructions by one or more processors causes the one or more processors to perform the further steps of:
retrieving the number file;
parsing the number file;
building an index entry based on the values parsed from the number file; and storing the index entry in an index that is stored apart from the storage device.

41. The computer-readable medium recited in claim 40, wherein execution of the one or more sequences of instructions by one or more processors causes the one or more processors to perform the further steps of:
sending the number file over the network to a client associated with the resource;
storing the number file in a server storage device of a server associated with the client.

42. The computer-readable medium recited in claim 41, wherein execution of the one or more sequences of instructions by one or more processors causes the one or more processors to perform the further steps of:
periodically polling the number file on the server associated with the client;
testing whether one of the telephone numbers stored in the number file matches a third telephone number stored in a database indexed by the index; and
updating the database when changes are detected in the number file.

43. The computer-readable medium recited in claim 42, wherein execution of the one or more sequences of instructions by one or more processors causes the one or more processors to perform the further steps of:
synchronizing the index to the database.

44. The computer-readable medium recited in claim 37, wherein execution of the one or more sequences of instructions by one or more processors causes the one or more processors to perform the step of storing a first telephone number by:
receiving a client identifier of a client associated with the resource;
generating a set of metadata that describes the resource, the location identifier, and the client identifier; and
storing the set of metadata in a persistent storage device associated with the client.

45. The computer-readable medium recited in claim 44, wherein execution of the one or more sequences of instructions by one or more processors causes the one or more processors to perform the further steps of:
assigning a randomly generated name to the set of metadata.

46. The computer-readable medium recited in claim 45, wherein execution of the one or more sequences of instructions by one or more processors causes the one or more processors to perform the further steps of:
instructing the client to store the metadata in a particular authorized location in the persistent storage device.

47. The computer-readable medium recited in claim 46, wherein execution of the one or more sequences of instructions by one or more processors causes the one or more processors to perform the further steps of:
registering the set of metadata and the randomly generated name in a database.

48. A method of locating a resource that is stored in a location in a network that is identified by a location identifier, comprising the steps of:
storing, in a metadata registry, metadata that describes the resource in association with the location identifier of the resource;
receiving a request to locate the resource, the request containing an element of the metadata;
retrieving the location identifier associated with the resource from the metadata registry based on the element; and
retrieving the resource over the network using the location identifier wherein,
said storing step includes storing a telephone number for the resource in the metadata;
said receiving step includes receiving a request to locate the resource based on the telephone number; and
said first retrieving step includes retrieving the location identifier associated with the telephone number from the metadata registry using the telephone number.

49. The method recited in claim 48, in which the step of storing metadata comprises the step of storing the metadata in a first storage device, and further comprising the steps of:
storing the telephone number in association with the location identifier in a second storage device associated with the resource.

50. The method recited in claim 48, in which the step of storing the telephone number comprises the step of storing the telephone number in a number file, and further comprising the steps of retrieving the number file;
parsing the number file;
building an index entry based on the values parsed from the number file; and
storing the index entry in an index of the metadata registry.

51. The method recited in claim 48, further comprising the steps of:
sending the number file over the network to a client associated with the resource;
storing the number file at the location.

52. The method recited in claim 50, further comprising the steps of:
periodically polling the number file that is stored at the client;
testing whether the telephone number stored in the number file matches a second telephone number stored in the metadata registry; and
updating the metadata registry' when a change is detected in the number file.

53. The method recited in claim 50, in which the step of building an index entry based on the values parsed from the number file and the step of storing the index entry further comprise the steps of:
establishing, in a memory, a first index, a second index, a first queue associated with the first index, and a second queue associated with the second index;
receiving a request to build an index entry based on the values parsed from the number file;
selecting the first queue and storing the request in the first queue;
when the first queue is sufficiently full, storing the contents of the first queue in the first index, and
concurrently selecting the second queue and storing a subsequent request to build an index entry in the second queue.

54. The method recited in claim 53, further comprising the step of alternately selecting the first queue and the second queue in response to successive requests to build an index entry.

55. The method recited in claim 49, in which the step of storing the telephone number comprises the step of storing the telephone number in a number file, and further comprising the steps of:
retrieving the number file;
parsing the number file;
testing whether the telephone number stored in the number file matches a second telephone number stored in the metadata registry;
updating the metadata registry when a change is detected in the number file;
building an updated index entry based on the values parsed from the number file; and
storing the index entry in an index of the metadata registry.

56. The method recited in claim 55, further comprising the steps of:
periodically polling the number file on the server associated with the client;
testing whether one of the telephone numbers stored in the number file matches a third
telephone number stored in a database indexed by the index; and
updating the database when changes are detected in the number file.

57. The method recited in claim 56, further comprising the step of: synchronizing the index to the database.

58. The method recited in claim 57, wherein the step of storing a first telephone number comprises the steps of:
receiving a client identifier of a client associated with the resource;
generating a set of metadata that describes the resource, the location identifier, and the client identifier; and
storing the set of metadata in a persistent storage device associated with the client.

59. The method recited in claim 51, in which the step of storing the number file at the location further comprises the step of storing the number file on a Web server that is part of a domain that is mapped to the metadata in the number file.

60. The method recited in claim 53, in which the step of establishing a first index, a second index, a first queue associated with the first index, and a second queue associated with the second index further comprises the steps of establishing the first queue in a first server and establishing the second queue in a second server that is separate from the first server.

61. A method of locating a resource, based upon a first telephone number, said resource stored in a network and identified by a location identifier, comprising the steps of:
storing the first telephone number relating to the resource and an associated location identifier of the resource;
receiving a request to locate the resource containing, said request including the first telephone number;
retrieving the location identifier associated with the first telephone number; and
identifying the resource to the user using the location identifier.

62. The method of claim 61, including the further step of the user communicating with the resource identified by the location identifier.

63. The method of claim 61, wherein said resource is a mobile telephone.

64. The method of claim 63, wherein the mobile telephone has video capabilities.

65. The method of claim 61, wherein the resource is a personal digital assistant (PDA).

66. A method of locating a resource that is stored in a location in a network that is identified by a location identifier, comprising the steps of:
storing, in a metadata registry in a first storage device, metadata that describes the resource in association with the location identifier of the resource;
receiving a request to locate the resource, the request containing an element of the metadata;
retrieving the location identifier associated with the resource from the metadata registry based on the element;
retrieving the resource over the network using the location identifier;
storing a telephone number for the resource in the metadata;
receiving a request to locate the resource based on the telephone number;
retrieving the location identifier associated with the telephone number from the metadata registry using the telephone number;
storing the telephone number in association with the location identifier in a number file in a second storage device associated with the resource;
retrieving the number file;
parsing the number file;
building an index entry based on the values parsed from the number file and storing the index entry in an index of the metadata registry by:
establishing, in a memory, a first index, a second index, a first queue associated with the first index, and a second queue associated with the second index;
receiving a request to build an index entry based on the values parsed from the number file;
selecting the first queue and storing the request in the first queue; and
when the first queue is sufficiently full, storing the contents of the first queue in the first index, and concurrently selecting the second queue and storing a subsequent request to build an index entry in the second queue.

67. A method of locating a resource that is stored in a location in a network that is identified by a location identifier, comprising the steps of:
storing, in a metadata registry in a first storage device, metadata that describes the resource in association with the location identifier of the resource;
receiving a request to locate the resource, the request containing an element of the metadata;
retrieving the location identifier associated with the resource from the metadata registry based on the element;
retrieving the resource over the network using the location identifier;
storing a telephone number for the resource in the metadata in association with the location identifier in a number file in a second storage device associated with the resource;
receiving a request to locate the resource based on the telephone number;
retrieving the location identifier associated with the telephone number from the metadata registry using the telephone number;
retrieving the number file, parsing the number file; building an index entry based on the values parsed from the number file; and storing the index entry in an index of the metadata registry;
establishing, in a memory, a first index, a second index, a first queue associated with the first index, and a second queue associated with the second index;
receiving a request to build an index entry based on the values parsed from the number file; selecting the first queue and storing the request in the first queue, and when the first queue is sufficiently full, storing the contents of the first queue in the first index, and concurrently selecting the second queue and storing a subsequent request to build an index entry in the second queue; and
alternately selecting the first queue and the second queue in response to successive requests to build an index entry.

68. A method of locating a resource that is stored in a location in a network that is identified by a location identifier, comprising the steps of:
storing, in a metadata registry in a first storage device, metadata that describes the resource in association with the location identifier of the resource;
receiving a request to locate the resource, the request containing at least a portion of a telephone number;
retrieving the location identifier associated with the resource from the metadata registry based on the telephone number; and
retrieving the resource over the network using the location identifier.

69. The method of claim 68, wherein the request comprises a complete telephone number.

70. The method of claim 69, wherein the telephone number includes an area code.

71. The method of claim 69, wherein the telephone number includes a country code.

72. The method of claim 69, wherein the telephone number includes one or more of a: a numeric, alphanumeric, symbol-based and mixed prefix and a numeric, alphanumeric, symbol-based and mixed extension.

73. The method of claim 68, wherein the at least a portion of the telephone number includes less than a complete telephone number and wherein the method includes the further step of matching the portion of the telephone number to one or more complete telephone numbers in a database.

74. The method of claim 68, wherein the telephone number is one or more of a mobile and landline-based telephone number.

75. The method of claim 68, wherein the resource facilitates delivery of one or more of: a web page, file, task or meeting request, e-mail , SMS message, voice and video message to an individual associated with the telephone number.

76. A method of retrieving a first web page by a user utilizing a web browser, comprising the steps of:
entering a telephone number in a data entry field of a web browser; and
receiving, at the web browser, the first web page associated with the telephone number.

77. The method of claim 76, wherein the first web page associated with the telephone number provides the user with one or more of:
predefined information about an individual associated with the telephone number, and
access to communications facilities associated with the individual associated with the telephone number.

78. The method of claim 77, wherein the communication facilities include one or more of:
a second web page;
an email
an instant message
a schedule task;
a meeting task;
a file;
the online status of the individual;
a chat facility;
a voice interaction facility; and
a video interaction facility.
